(19) United States
(12) Patent Application Publication
(10) Pub. No.: US 2024/0219851 A1
(43) Pub. Date: Jul. 4, 2024

(54) TONER FOR DEVELOPING ELECTROSTATIC CHARGE IMAGE, ELECTROSTATIC CHARGE IMAGE DEVELOPER, TONER CARTRIDGE, PROCESS CARTRIDGE, IMAGE FORMING APPARATUS, AND IMAGE FORMING METHOD

(71) Applicant: FUJIFILM BUSINESS INNOVATION CORP., Tokyo (JP)

(72) Inventors: Shinya SAKAMOTO, Kanagawa (JP); Narumasa SATO, Kanagawa (JP); Yumi TANAKA, Kanagawa (JP)

(73) Assignee: FUJIFILM BUSINESS INNOVATION CORP., Tokyo (JP)

(21) Appl. No.: 18/327,325

(22) Filed: Jun. 1, 2023

(30) Foreign Application Priority Data
Dec. 26, 2022 (JP) 2022-207829

(51) Int. Cl. G03G 9/08; G03G 9/087; G03G 15/08; G03G 21/18

(52) U.S. Cl. CPC G03G 9/0821; G03G 9/08728; G03G 9/08755; G03G 15/0865; G03G 21/1814

(57) ABSTRACT

A toner for developing an electrostatic charge image contains toner particles containing: a binder resin containing an amorphous resin and a crystalline resin; and resin particles. In differential scanning calorimetry, an endothermic peak temperature Tc of the crystalline resin is 60° C. or higher and 75° C. or lower, a ratio (Q1/Q2) of a heat absorption Q1 of the crystalline resin calculated by performing differential scanning calorimetry on the toner that has been melted at 150° C., then cooled to a temperature 10° C. lower than the endothermic peak temperature Tc, and then retained thereat for 1 minute, to a heat absorption Q2 of the crystalline resin calculated by performing differential scanning calorimetry on the toner that has been melted at 150° C., then cooled to a temperature 10° C. lower than the endothermic peak temperature Tc, and then retained thereat for 30 minutes is 0.15 or more. A maximum value of a loss coefficient tan δ at 50° C. or higher and 70° C. or lower is less than 1.2. An amount of the crystalline resin contained relative to a total amount of the amorphous resin and the crystalline resin is 15 mass % or more and 25 mass % or less. The resin particles are crosslinked resin particles.

### CROSS-REFERENCE TO RELATED APPLICATIONS

This application is based on and claims priority under 35 USC 119 from Japanese Patent Application No. 2022-207829 filed Dec. 26, 2022.

### BACKGROUND

### (i) Technical Field

The present disclosure relates to a toner for developing an electrostatic charge image. an electrostatic charge image developer, a toner cartridge, a process cartridge, an image forming apparatus, and an image forming method.

### (ii) Related Art

Japanese Unexamined Patent Application Publication No. 2017-009982 proposes a toner that is thermally fixed to an image carrier and that has a storage modulus G′ satisfying conditions below as measured with a rheometer:
·Storage modulus G′ at 100° C. in a heating process is 1×10³ to 1×10⁶ Pa
·Storage modulus G′ at 100° C. in a cooling process is 1×10³ to 1×10⁶ Pa
   where the value of storage modulus G′ at 100° C. is higher in the cooling process than in the heating process.

Japanese Unexamined Patent Application Publication No. 2014-199423 proposes a toner for developing an electrostatic charge image, the toner containing at least a binder resin and a coloring agent, in which the binder resin contains a crystalline resin (A), the crystalline resin (A) contains two or more crystalline resins (a), and an endothermic peak temperature group that includes all endothermic peak temperatures of the two or more crystalline resins (a) has two or more different endothermic peak temperatures.

Japanese Unexamined Patent Application Publication No. 2011-197659 proposes a toner for developing an electrostatic latent image, the toner containing a binder resin and a coloring agent, in which the binder resin contains a crystalline resin and an amorphous resin obtained from a radically polymerizable monomer unit containing a styrene monomer and a (meth)acrylate monomer, and in which a ratio (Q2/Q1) of a heat absorption Q2 based on an endothermic peak derived from the crystalline resin in a second heating process of increasing the temperature from 0° C.to 200° C. to a heat absorption Q1 based on an endothermic peak derived from the crystalline resin in a first heating process of increasing the temperature from 0° C. to 200° ° C. is 0.85 or more.

Japanese Unexamined Patent Application Publication No. 2016-070956 proposes a toner for developing an electrostatic charge image, the toner containing a binder resin and a crystalline substance, in which, in a DSC curve measured with a differential scanning calorimeter, an endothermic peak is present at 90° C. or higher and 115° C. or lower; and, in dynamic viscoelasticity measurement, a local maximum of tan δ is present at 115° C. or higher and 125° C. or lower, the local maximum of tan δ is 1 or more and 2 or less, and G″ at the local maximum of tan δ is 10³ or more and 10⁴ or less.

International Publication No. 2006/035862 proposes a toner for developing an electrostatic charge image, the toner containing at least a binder resin and a coloring agent, in which the binder resin contains an amorphous resin and a crystalline resin, and, in a DSC curve of the toner obtained in a heating process measured by a differential scanning calorimeter, there is an endothermic peak having a starting point onset temperature of 100 to 150° C., an end point onset temperature of 150 to 200° C., and a half width of 10 to 40° C.

Japanese Unexamined Patent Application Publication No. 2021-117422 proposes a toner for developing an electrostatic charge image, the toner containing toner base particles that contain at least a binder resin, a coloring agent, and a releasing agent, in which the binder resin contains at least a crystalline polyester resin, and, in a temperature-modulated viscoelasticity measurement of the toner for developing an electrostatic charge image, the ratio [tan δ(60° C.)/tan δ (45° C.)] of the loss tangent tan δ(45° C.) at a temperature of 45° C. and the loss tangent tan δ(60° C.) at a temperature of 60° C. is in the range of 2.5 to 4.0, and there is one local maximum in a tan δ curve plotted versus temperature in the temperature range of 60 to 70° C.

Japanese Unexamined Patent Application Publication No. 2020-204686 proposes a toner for developing an electrostatic charge image, the toner containing toner base particles that contain at least a releasing agent and a binder resin, in which the binder resin contains at least a crystalline polyester resin, and, in a temperature-modulated viscoelasticity measurement of the toner for developing an electrostatic charge image, the following formulac (1) to (3) are satisfied, and, in the temperature range of 60 to 70° C., a tan δ curve as a function of temperature has one local maximum, where the tangent losses (tan δ) of dynamic viscoelasticity at temperature of 45° C., 50° C., 55° C., and 60° C. are respectively represented by tan δ(45° C.), tan δ(50° C., tan δ(55° C.), and tan δ(60° C.), the value of the ratio of tan δ(55° C.) to tan δ(45° C.) is represented by [tan δ(55° C.)/tan δ(45° C.)], the value of the ratio of tan δ(60° C.) to tan δ(50° C.) is represented by [tan δ(60° C.)/tan δ(50° C.], and the value of the ratio of tan) δ(60° C.) to tan δ(55° C.) is represented by [tan δ(60° C.)/tan δ(55° C.]:

Formula (1): [tan δ(60° C.)/tan δ(55° C.)]<[tan δ(55° C.)/tan δ(45° C.)]

Formula (2): 1.0≤[tan δ(55° C.)/tan δ(45° C.)]≤5.0

Formula (3): [(tan δ(60° C.)/tan δ(50° C.)]≤2.5

Japanese Unexamined Patent Application Publication No. 2015-172646 proposes a toner for developing an electrostatic charge image, the toner containing a binder resin and at least two releasing agents having different melting temperatures, in which a local maximum of tan δ is present in the range of 60° C. or higher and 75° C. or lower, there are at least three recrystallization peaks of the releasing agents in differential scanning calorimetry, and the temperature (Tw1) of the peak that exhibits the highest amount of heat among the recrystallization peaks is present within the temperature range of +0.1° C. or more and +15° C. or less relative to the temperature of the local maximum of tan δ.

Japanese Unexamined Patent Application Publication No. 2019-194682 proposes a toner that includes toner particles that contain a binder resin and a crystalline polyester resin, in which the binder resin is an amorphous polyester resin that has a linear alkyl group at a molecular chain terminal, the crystalline polyester resin is a polycondensation product between a diol and a dicarboxylic acid, the number CaPES of carbon atoms in the linear alkyl group, the number COH of the carbon atoms in the diol, and the number CAc of carbon atoms in the dicarboxylic acid excluding those that belong to the carboxy group satisfy the relationship (1) and the relationship (2) or (3) below, and the glass transition temperature of the toner measured with a differential scanning calorimeter is 40.0° C. or higher and 55.0° C. or lower:

8≤CaPES≤20 (1)

CAc/COH≥3.5 and 0≤|CAc−CaPES|≤3 (2)

COH/CAc≥3.5 and 0≤|COH−CaPES|≤3. (3)

Japanese Unexamined Patent Application Publication No. 2018-087901 proposes a toner for developing an electrostatic latent image, the toner containing at least a binder resin, a coloring agent, and a releasing agent, in which the binder resin contains at least a styrene-acrylic resin and a crystalline resin, the coloring agent has an average dispersion diameter in the range of 100 to 400 nm in a cross section of the toner for developing an electrostatic latent image, the exothermic peak top temperature of the toner for developing an electrostatic latent image during a cooling process in differential scanning calorimetry is in the range of 60 to 85° C., and the half width of the exothermic peak is 7° C. or less.

Japanese Unexamined Patent Application Publication No. 2017-090810 proposes a toner that contains at least an amorphous polyester resin and a crystalline resin as binder resins, in which, in a cooling chart of the toner measured by differential scanning calorimetry (DSC), an exothermic peak having a half width of 10° C. or less exists in the range of 40° C. or higher and 60° C. or lower, and the difference between the endothermic peak temperature and the exothermic peak temperature in a heating chart of the toner by DSC is 0° C. or more and 30° C. or less.

### SUMMARY

Aspects of non-limiting embodiments of the present disclosure relate to providing a toner for developing an electrostatic charge image, the toner including toner particles containing: a binder resin containing an amorphous resin; and a crystalline resin in which, in differential scanning calorimetry, an endothermic peak temperature Te of the crystalline resin is 60° C. or higher and 75° C. or lower, and this toner reduces print blocking (a phenomenon in which images stick to each other or stick to recording media when recording media having images formed thereon are stacked on top of each other and in which image defects such as image nonuniformity and image omission occur when the recording media are separated) and exhibits excellent fixability compared to when a ratio (Q1/Q2) of a heat absorption Q1 of the crystalline resin calculated by performing differential scanning calorimetry on the toner that has been melted at 150° C., then cooled to a temperature 10° C. lower than the endothermic peak temperature Tc, and then retained thereat for 1 minute, to a heat absorption Q2 of the crystalline resin calculated by performing differential scanning calorimetry on the toner that has been melted at 150° C., then cooled to a temperature 10° C. lower than the endothermic peak temperature Tc, and then retained thereat for 30 minutes is less than 0.15, when a maximum value of a loss coefficient tan δ at 50° C. or higher and 70° C. or lower is 1.2 or more, when an amount of the crystalline resin contained relative to a total amount of the amorphous resin and the crystalline resin is less than 15 mass% or more than 25 mass %, or less, and when the toner particles contain resin particles that are not crosslinked resin particles.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a toner for developing an electrostatic charge image, the toner including toner particles containing: a binder resin containing an amorphous resin; and a crystalline resin, and resin particles, in which: in differential scanning calorimetry, an endothermic peak temperature Tc of the crystalline resin is 60° C. or higher and 75° C. or lower; a ratio (Q1/Q2) of a heat absorption Q1 of the crystalline resin calculated by performing differential scanning calorimetry on the toner that has been melted at 150° C., then cooled to a temperature 10° C. lower than the endothermic peak temperature Tc, and then retained thereat for 1 minute, to a heat absorption Q2 of the crystalline resin calculated by performing differential scanning calorimetry on the toner that has been melted at 150° C., then cooled to a temperature 10° C. lower than the endothermic peak temperature Tc, and then retained thereat for 30 minutes is 0.15 or more; a maximum value of a loss coefficient tan δ at 50° C. or higher and 70° C. or lower is less than 1.2; an amount of the crystalline resin contained relative to a total amount of the amorphous resin and the crystalline resin is 15 mass % or more and 25 mass % or less; and the resin particles are crosslinked resin particles.

### BRIEF DESCRIPTION OF THE DRAWINGS

Exemplary embodiments of the present disclosure will be described in detail based on the following figures, wherein:

FIG. 1 is a schematic diagram illustrating an image forming apparatus according to an exemplary embodiment; and

FIG. 2 is a schematic diagram illustrating a process cartridge according to an exemplary embodiment.

### DETAILED DESCRIPTION

Exemplary embodiments that illustrate some examples of the present disclosure will now be described. These descriptions and examples are relevant to the exemplary embodiments, and do not limit the scope of the disclosure.

In this description, in numerical ranges described stepwise, the upper limit or the lower limit of one numerical range may be substituted with an upper limit or a lower limit of a different numerical range also described stepwise. In addition, in any numerical range described in this description, the upper limit or the lower limit of the numerical range may be substituted with a value indicated in Examples.

Each of the components may contain more than one corresponding substances.

When the amount of a component in a composition is described and when there are two or more substances that correspond to that component in the composition, the amount is the total amount of the two or more substances in the composition unless otherwise noted.

The term “step” refers not only to an independent step but also to any feature that attains the expected effect of the step although such a feature may not be clearly distinguishable from other steps.

### Toner for Developing Electrostatic Charge Image

A toner for developing an electrostatic charge image according to an exemplary embodiment (hereinafter the toner for developing an electrostatic charge image may be simply referred to as the “toner”) contains toner particles containing a binder resin containing an amorphous resin and a crystalline resin, and resin particles, in which, in differential scanning calorimetry, an endothermic peak temperature Tc of the crystalline resin is 60° C. or higher and 75° C. or lower, a ratio (Q1/Q2) of a heat absorption Q1 of the crystalline resin calculated by performing differential scanning calorimetry on the toner that has been melted at 150° C., then cooled to a temperature 10° C. lower than the endothermic peak temperature Tc, and then retained thereat for 1 minute, to a heat absorption Q2 of the crystalline resin calculated by performing differential scanning calorimetry on the toner that has been melted at 150° C., then cooled to a temperature 10° C. lower than the endothermic peak temperature Tc, and then retained thereat for 30 minutes is 0.15 or more, a maximum value of a loss coefficient tan δ at 50° C. or higher and 70° C. or lower is less than 1.2, an amount of the crystalline resin contained relative to a total amount of the amorphous resin and the crystalline resin is 15 mass % or more and 25 mass % or less, and the resin particles are crosslinked resin particles.

The toner according to this exemplary embodiment reduces print blocking and exhibits excellent fixability due to the aforementioned features. The reason for this is presumably as follows.

According to a typical toner that has toner particles containing a binder resin containing an amorphous resin and a crystalline resin, and that has a crystalline resin-derived endothermic peak temperature Tc of 60° C. or higher and 75° C. or lower in differential scanning calorimetry, the low temperature fixability is excellent; however, the toner solidifies slowly as the toner cools after being fixed to the recording medium, and sometimes remains soft even at a decreased temperature. Thus, when recording media with images formed thereon are stacked on top of each other, print blocking is likely to occur.

According to the toner of the exemplary embodiment, the ratio (Q1/Q2) of a heat absorption Q1 of the crystalline resin calculated by performing differential scanning calorimetry on the toner that has been melted at 150° C., then cooled to a temperature 10° C. lower than the endothermic peak temperature Tc, and then retained thereat for 1 minute, to a heat absorption Q2 of the crystalline resin calculated by performing differential scanning calorimetry on the toner that has been melted at 150° C., then cooled to a temperature 10° C. lower than the endothermic peak temperature Tc, and then retained thereat for 30 minutes is 0.15 or more. The amount of the crystalline resin contained relative to the total amount of the amorphous resin and the crystalline resin is 15 mass % or more and 25 mass % or less. In this manner, the toner can maintain the low-temperature fixability and yet can rapidly solidify as the toner cools after being fixed to the recording medium.

According to the toner of the present exemplary embodiment, the maximum value of the loss coefficient tan δ at 50° C. or higher and 70° C. or lower is less than 1.2. In this manner, the toner fixed to the recording medium is likely to exhibit elasticity, and when recording media having images formed thereon are stacked on top of each other, the images rarely undergo deformation.

According to the toner of the present exemplary embodiment, the toner particles contain resin particles, and the resin particles are crosslinked resin particles. Since the crosslinked resin particles help increase the elasticity of the toner, the toner fixed onto the recording medium is likely to exhibit elasticity. As a result, when recording media having image formed thereon are stacked on top of each other, the images rarely undergo deformation, the releasability of the toner particles from the fixing roll during the fixing step is increased, image omission caused by migration of the toner particles and toner fixed images onto the fixing roll is reduced, and high fixability can be realized. Furthermore, according to the crosslinked resin particles, which have crosslinked polymer chains, polymer chains of the amorphous resin and the crystalline resin do not penetrate into the particles and remain immiscible to each other; thus, during cooling, the crosslinked resin particles serve as a so-called nucleating agent that accelerates the phase separation between the amorphous resin and the crystalline resin and offer an effect of accelerating toner solidification.

It is presumed that, due to these features, the toner according to this exemplary embodiment reduces print blocking.

The toner according to this exemplary embodiment will now be described in detail.

The toner according to the exemplary embodiment contains toner particles and, if necessary, an external additive.

### Toner Particles

Toner particles contain, for example, a binder resin, resin particles, and, optionally, a coloring agent, a releasing agent, and other additives.

### Binder Resin

The binder resin contains an amorphous resin and a crystalline resin.

The amorphous resin refers to a resin that exhibits no clear endothermic peak but a stepwise endothermic change in differential scanning calorimetry (DSC). The crystalline resin refers to a resin that exhibits not a stepwise endothermic change but a clear endothermic peak in differential scanning calorimetry (DSC).

Specifically, the amorphous resin refers to a resin having a half width exceeding 10° C. or a resin that exhibits no clear endothermic peak, and the crystalline resin refers to a resin having an endothermic peak having a half width of 10° C. or less when measured at a heating rate of 10° C./min.

The binder resin may be a polyester resin.

By employing a polyester resin as the binder resin, the affinity between the binder resin and the resin particles is improved, and the resin particles are likely to disperse in the toner particles nearly evenly.

The amount of the binder resin contained relative to the entire toner particles is preferably 40 mass % or more and 95 mass % or less, more preferably 50 mass % or more and 90 mass % or less, and yet more preferably 60 mass % or more and 85 mass % or less.

### Amorphous Resin

Examples of the amorphous resin include amorphous polyester resins, amorphous vinyl resins (for example, styrene-acrylic resins), epoxy resins, polycarbonate resins, and polyurethane resins. Among these, amorphous polyester resins and amorphous vinyl resins (particularly, styrene-acrylic resins) are preferable, and amorphous polyester resins are more preferable.

### Amorphous Polyester Resin

An example of the amorphous polyester resin is a polycondensation product between a polycarboxylic acid and a polyhydric alcohol. The amorphous polyester resin may be a commercially available product or may be synthesized.

Examples of the polycarboxylic acid include aliphatic dicarboxylic acids (for example, oxalic acid, malonic acid, maleic acid, fumaric acid, citraconic acid, itaconic acid, glutaconic acid, succinic acid, alkenylsuccinic acid, adipic acid, and sebacic acid), alicyclic dicarboxylic acids (for example, cyclohexane dicarboxylic acid), aromatic dicarboxylic acids (for example, terephthalic acid, isophthalic acid, phthalic acid, and naphthalenedicarboxylic acid), anhydrides thereof, and lower (for example, 1 to 5 carbon atoms) alkyl esters thereof. Among these, aromatic dicarboxylic acids are preferable as the polycarboxylic acid.

A combination of a dicarboxylic acid and a tri- or higher carboxylic acid that can form a crosslinked structure or a branched structure may be used as the polycarboxylic acid. Examples of the tri- or higher carboxylic acid include trimellitic acid, pyromellitic acid, anhydrides thereof, and lower (for example, 1 to 5 carbon atoms) alkyl esters thereof.

One polycarboxylic acid may be used alone or two or more polycarboxylic acids may be used in combination.

Examples of the polyhydric alcohol include aliphatic diols (for example, ethylene glycol, diethylene glycol, tricthylene glycol, propylene glycol, butanediol, hexanediol, and neopentyl glycol), alicyclic diols (for example, cyclohexanediol, cyclohexanedimethanol, and hydrogenated bisphenol A), and aromatic diols (for example, ethylene oxide adducts of bisphenol A and propylene oxide adducts of bisphenol A). Among these, aromatic diols and alicyclic diols are preferable, and aromatic diols are more preferable as the polyhydric alcohol.

A combination of a diol and a tri- or higher polyhydric alcohol that can form a crosslinked structure or a branched structure may be used as the polyhydric alcohol. Examples of the tri- or higher polyhydric alcohol include glycerin, trimethylolpropane, and pentaerythritol.

One polyhydric alcohol may be used alone or two or more polyhydric alcohols may be used in combination.

The glass transition temperature (Tg) of the amorphous polyester resin is preferably 50° C. or higher and 80° C. or lower and more preferably 50° C. or higher and 65° C. or lower.

The glass transition temperature of the amorphous polyester resin is determined from a DSC curve obtained by differential scanning calorimetry (DSC), more specifically, according to “extrapolated glass transition onset temperature” described in the method for determining the glass transition temperature in JIS K 7121-1987 “Testing Methods for Transition Temperatures of Plastics”.

The weight-average molecular weight (Mw) of the amorphous polyester resin is preferably 5000 or more and 1000000 or less and more preferably 7000 or more and 500000 or less.

The number-average molecular weight (Mn) of the amorphous polyester resin is preferably 2000 or more and 100000 or less.

The molecular weight distribution (Mw/Mn) of the amorphous polyester resin is preferably 1.5 or more and 100 or less and more preferably 2 or more and 60 or less.

The weight-average molecular weight and the number-average molecular weight of the amorphous polyester resin are measured by gel permeation chromatography (GPC). The molecular weight measurement by GPC is performed by using GPC. HLC-8120GPC produced by TOSOH CORPORATION as a measuring instrument with columns TSKgel Super HM-M (15 cm) produced by TOSOH CORPORATION, and a tetrahydrofuran solvent. The weight-average molecular weight and the number-average molecular weight are calculated from the measurement results by using the molecular weight calibration curves obtained from monodisperse polystyrene standard samples.

The amorphous polyester resin is obtained by a known synthesis method. Specifically, for example, the amorphous polyester resin is obtained by a method that involves setting the polymerization temperature to 180ºC or higher and 230° C. or lower, decreasing the pressure inside the reaction system as necessary, and performing the reaction while removing water and alcohol generated during condensation.

When raw material monomers do not dissolve or mix at the reaction temperature, a solvent having a high boiling point may be added as a solubilizer to dissolve the monomers. In this case, the polycondensation reaction is carried out while distilling away the solubilizer. When there are monomers that are poorly miscible with each other, such monomers may be preliminarily condensed with an acid or an alcohol to be polycondensed with that monomer and then be subjected to polycondensation with other components.

An example of the amorphous polyester resin is an amorphous polyester resin having an aliphatic dicarboxylic acid unit. One aliphatic dicarboxylic acid unit or two or more aliphatic dicarboxylic acid units may be contained.

The aliphatic dicarboxylic acid that gives the aliphatic dicarboxylic acid unit may be a saturated or unsaturated aliphatic dicarboxylic acid, and is preferably a saturated aliphatic dicarboxylic acid.

Examples of the saturated aliphatic dicarboxylic acid include linear dicarboxylic acids such as oxalic acid, malonic acid, succinic acid, glutaric acid, adipic acid, pimelic acid, suberic acid, azclaic acid, and sebacic acid, and branched dicarboxylic acids such as methylmalonic acid, ethylmalonic acid, dimethylmalonic acid, methylsuccinic acid, 2,2-dimethylsuccinic acid, 2,3-dimethylsuccinic acid, and tetramethylsuccinic acid.

Examples of the unsaturated aliphatic dicarboxylic acid include maleic acid, fumaric acid, citraconic acid, itaconic acid, and glutaconic acid.

An example of the amorphous polyester resin is an amorphous polyester resin having a unit represented by formula (1). The number of units represented by formula (1) may be 1 or more than 1.

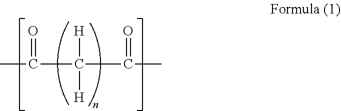

In formula (1), n represents an integer of 4 or more and 12 or less. Here, n is preferably an integer of 4 or more and 11 or less, more preferably 4 or more and 10 or less, and yet more preferably 4 or more and 8 or less. When n is less than 4, the amount of the molecular ester groups that have high molecular mobility increases, the compatibility with the crystalline resin increases, the phase separation speed decreases, and the toner solidification speed decreases. Moreover, the rigidity of the resin is degraded, and toner particles exhibit degraded resistance to impact such as stirring stress inside a developing device. When n exceeds 10, methylene chain moieties tend to align and this makes some portion crystalline and degrades the impact resistance as described above.

### Crystalline Resin

Examples of the crystalline resin include crystalline polyester resins and crystalline vinyl resins (for example, polyalkylene resins and long-chain alkyl (meth)acrylate resins). From the viewpoints of the mechanical strength and low-temperature fixability of the toner, crystalline polyester resins are preferable.

### Crystalline Polyester Resin

An example of the crystalline polyester resin is a polycondensation product between a polycarboxylic acid and a polyhydric alcohol. The crystalline polyester resin may be a commercially available product or may be synthesized.

From the viewpoint of ease of forming the crystal structure, the crystalline polyester resin may be a polycondensation product obtained by using a linear aliphatic polymerizable monomer rather than a polymerizable monomer having an aromatic ring.

Examples of the polycarboxylic acid include aliphatic dicarboxylic acids (for example, oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (for example, dibasic acids such as phthalic acid, isophthalic acid, terephthalic acid, and naphthalene-2,6-dicarboxylic acid), anhydrides thereof, and lower (for example, 1 to 5 carbon atoms) alkyl esters thereof.

A combination of a dicarboxylic acid and a tri- or higher carboxylic acid that can form a crosslinked structure or a branched structure may be used as the polycarboxylic acid. Examples of the tri-or higher carboxylic acid include aromatic carboxylic acids (for example, 1,2,3-benzenetricarboxylic acid, 1,2,4-benzenetricarboxylic acid, and 1,2,4-naphthalenetricarboxylic acid), anhydrides thereof, and lower (for example, 1 to 5 carbon atoms) alkyl esters thereof.

A combination of a dicarboxylic acid, a dicarboxylic acid having a sulfonic acid group, and a dicarboxylic acid having an ethylenic double bond maybe used as the polycarboxylic acid.

One polycarboxylic acid may be used alone or two or more polycarboxylic acids may be used in combination.

Examples of the polyhydric alcohol include aliphatic diols (for example, linear aliphatic diols having a main chain moiety having 7 to 20 carbon atoms). Examples of the aliphatic diol include ethylene glycol, 1,3-propanediol, 1,4-butanediol, 1,5-pentanediol, 1,6-hexanediol, 1,7-heptanediol, 1.8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanediol. Among these, 1,8-octanediol, 1,9-nonanediol, and 1,10-decanediol are preferable as the aliphatic diol.

A combination of a diol and a tri- or higher alcohol that can form a crosslinked structure or a branched structure may be used as the polyhydric alcohol. Examples of the tri- or higher alcohol include glycerin, trimethylolethane, trimethylolpropane, and pentaerythritol.

One polyhydric alcohol may be used alone or two or more polyhydric alcohols may be used in combination.

The polyhydric alcohol may contain an aliphatic diol. The aliphatic diol preferably accounts for 80 mol % or more and more preferably 90 mol % or more of the polyhydric alcohol.

The melting temperature of the crystalline polyester resin is preferably 50° C. or higher and 100° C. or lower, more preferably 55° C. or higher and 90° C. or lower, and yet more preferably 60° ° C.or higher and 85° C. or lower.

The melting temperature of the crystalline polyester resin is determined from a DSC curve obtained by differential scanning calorimetry (DSC) according to “Melting peak temperature” described in the method for determining the melting temperature in JIS K 7121-1987 “Testing Methods for Transition Temperatures of Plastics”.

The weight-average molecular weight (Mw) of the crystalline polyester resin may be 6000 or more and 35000 or less.

An example of the crystalline polyester resin is a crystalline polyester resin having an aliphatic dicarboxylic acid unit. One aliphatic dicarboxylic acid unit or two or more aliphatic dicarboxylic acid units may be used.

The aliphatic dicarboxylic acid that gives the aliphatic dicarboxylic acid unit may be a saturated or unsaturated aliphatic dicarboxylic acid, and is preferably a saturated aliphatic dicarboxylic acid.

Examples of the saturated aliphatic dicarboxylic acid include linear dicarboxylic acids such as oxalic acid, malonic acid, succinic acid, glutaric acid, adipic acid, pimelic acid, suberic acid, azelaic acid, and sebacic acid, and branched dicarboxylic acids such as methylmalonic acid, ethylmalonic acid, dimethylmalonic acid, methylsuccinic acid, 2,2-dimethylsuccinic acid, 2,3-dimethylsuccinic acid, and tetramethylsuccinic acid.

Examples of the unsaturated aliphatic dicarboxylic acid include maleic acid, fumaric acid, citraconic acid, itaconic acid, and glutaconic acid.

An example form of the crystalline polyester resin is a crystalline polyester resin having a unit represented by formula (2). The number of units represented by formula (2) may be 1 or more than 1.

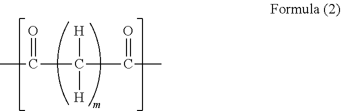

In formula (2), m represents an integer of 4 or more and 12 or less. Here, m is preferably an integer of 5 or more and 12 or less, more preferably 6 or more and 11 or less, and yet more preferably 8 or more and 10 or less. When m is less than 4, the amount of the molecular ester groups that have high molecular mobility increases, the compatibility with the amorphous resin increases, the phase separation speed decreases, and the toner solidification speed decreases.

### Relationship Between Amorphous Resin and Crystalline Resin

The amorphous resin may contain an amorphous polyester resin having an aliphatic dicarboxylic acid unit, and the crystalline resin may contain a crystalline polyester resin having an aliphatic dicarboxylic acid unit.

Furthermore, the amorphous polyester resin may contain an amorphous polyester resin having a unit represented by formula (1) above, and the crystalline polyester resin may contain a crystalline polyester resin having a unit represented by formula (2) above.

The unit represented by formula (1) above may account for 1 mass % or more and 30 mass % or less of all dicarboxylic acid units in the amorphous polyester resin having an aliphatic dicarboxylic acid unit, and the unit represented by formula (2) above may account for 60 mass % or more and 100 mass % or less of all dicarboxylic acid units in the crystalline polyester resin having an aliphatic dicarboxylic acid unit.

When the binder resin in the toner of the present exemplary embodiment contains an amorphous resin and a crystalline resin having the aforementioned features, flexibility increases compared to when no aliphatic dicarboxylic acid units are contained, and thus the crosslinked resin particles can disperse more evenly, the toner is likely to have higher elasticity, and thus the toner fixed onto a recording medium easily exhibits elasticity.

The unit represented by formula (1) above more preferably accounts for 4 mass % or more and 30 mass % or less and yet more preferably accounts for 20 mass % or more and 30 mass % or less of all dicarboxylic acid units in the amorphous polyester resin having an aliphatic dicarboxylic acid unit.

The unit represented by formula (2) above more preferably accounts for 70 mass % or more and 100 mass % or less and yet more preferably accounts for 80 mass % or more and 100 mass % or less of all dicarboxylic acid units in the crystalline polyester resin having an aliphatic dicarboxylic acid unit.

A mass ratio R1 of the unit represented by formula (1) above to all dicarboxylic acid units in the entire amorphous polyester resin and a mass ratio R2 of the unit represented by formula (2) above to all dicarboxylic acid units in the entire crystalline polyester resin are preferably 0.01≤R1/R2≤0.40, more preferably 0.05≤R1/R2≤0.3, and yet more preferably 0.1≤R1/R2≤0.2.

When R1/R2 is 0.01 or more, the affinity between the amorphous resin and the crystalline resin increases and flexibility increases compared to when R1/R2 is less than 0.01. and thus the crosslinked resin particles can disperse more evenly, the toner is likely to have higher elasticity, and thus the toner fixed onto a recording medium easily exhibits elasticity.

When R1/R2 is 0.4 or less, the affinity between the amorphous resin and the crystalline resin falls within an appropriate range; thus, compared to when R1/R2 exceeds 0.4, aggregation of the crosslinked resin particles in the toner particles caused by excessively high flexibility is reduced, the particles can disperse more evenly, the toner is likely to have higher elasticity, and thus the toner fixed onto a recording medium easily exhibits elasticity.

The difference (SP value (Amo)−SP value (Cry)) between a solubility parameter SP value (Amo) of the amorphous resin and a solubility parameter SP value (Cry) of the crystalline resin is preferably 0 or more and 0.9 or less, more preferably 0.2 or more and 0.8 or less, and yet more preferably 0.3 or more and 0.7 or less.

When the difference between the solubility parameter SP value (Amo) of the amorphous resin and the solubility parameter SP value (Cry) of the crystalline resin is 0 or more and 0.9 or less, the toner can more rapidly solidify as the toner cools after being fixed to the recording medium.

Here, the solubility parameter SP value (S) of the specified resin particles and the solubility parameter SP value (R) of the binder resin (unit: (cal/cm³)^{1/2}) are calculated by the Okitsu method. The Okitsu method is described in detail in Journal of the Adhesion Society of Japan:adhesion 29(5) (1993).

The amount of the crystalline resin contained relative to the total amount of the amorphous resin and the crystalline resin is preferably 15 mass % or more and 25 mass % or less, and, from the viewpoint of low-temperature fixability, preferably 16 mass % or more and 25 mass % or less, and more preferably 18 mass % or more and 22 mass % or less.

### Resin Particles

The toner particles contain resin particles. These resin particles are crosslinked resin particles.

The crosslinked resin particles are resin particles that have a crosslinked structure.

Here, the phrase “the resin particles have a crosslinked structure” means that there is a bridged structure between particular atoms in a polymer structure contained in the resin particles.

Examples of the crosslinked structure in the resin particles include a crosslinked structure crosslinked by an ionic bond and a crosslinked structure crosslinked by a covalent bond. In particular, the crosslinked resin particles may have a crosslinked structure crosslinked by a covalent bond.

Here, the crosslinked resin particles contained in the toner particles contained in the toner of the present exemplary embodiment are referred to as the “specified resin particles”.

Examples of the type of resin used in the specified resin particles include polyolefin resins (polyethylene, polypropylene, etc.), styrene resins (polystyrene, a-polymethylstyrene, etc.), (meth)acrylic resins (polymethyl methacrylate, polyacrylonitrile, etc.), epoxy resins, polyurethane resins, polyurea resins, polyamide resins, polyamide resins, polycarbonate resins, polyether resins, polyester resins, and copolymer resins of these. These resins may be used alone or in combination as necessary.

The resin used in the specified resin particles is preferably styrene-(meth)acrylic copolymer resin among the aforementioned resins.

In other words, the specified resin particles are preferably styrene-(meth)acrylic copolymer resin particles.

When styrene-(meth)acrylic copolymer resin particles are used as the specified resin particles, the toner particles more easily exhibit elasticity.

In order to impart elasticity to the toner particles that contain a crystalline resin and have excellent low-temperature fixability by using the specified resin particles, the specified resin particles are to have high affinity with the crystalline resin. The crystalline resin has a linear methylene chain that exhibits crystallinity in a polymer chain, and it is presumed that the structural similarity between the linear methylene chain in the crystalline resin and the methylene chain constituting the main chain of the styrene-(meth)acrylic copolymer resin results in high affinity and case of imparting elasticity. Meanwhile, when the (meth)acryl moiety of the styrene-(meth)acrylic copolymer resin contains a long-chain alkyl chain, the affinity between the linear methylene chain in the crystalline resin and the (meth)acryl moiety in the side chain moiety increases, and this decreases the affinity as the styrene-(meth)acrylic copolymer resin and detriments the effect of imparting elasticity to the toner particles. From such a viewpoint, the number of carbon atoms in the alkyl chain in the (meth)acryl moiety may be 6 or less.

The storage modulus G′(Rp) of the specified resin particles at 50° C. is preferably 1×10⁵ Pa or more and 5×10⁷ Pa or less and more preferably 1×10⁵ Pa or more and 5×10⁶ Pa or less.

When the storage modulus G′(Rp) of the specified resin particles at 50° C. is 1×10⁵ Pa or more and 5×10⁷ Pa or less, the specified resin particles easily exhibit a particular elasticity or higher. Thus, the toner fixed to the recording medium is likely to exhibit elasticity, and when recording media having images formed thereon are stacked on top of each other, the images rarely undergo deformation.

The number-average particle diameter of the specified resin particles is preferably 60 nm or more and 300 nm or less, more preferably 100 nm or more and 200 nm or less, and yet more preferably 130 nm or more and 170 nm or less.

When the number-average particle diameter of the specified resin particles is 60 nm or more and 300 nm or less, the dispersibility of the specified resin particles in the toner particles is improved.

When the number-average particle diameter is less than 60 nm, aggregation of the resin particles is likely to occur, and dispersibility in the toner particles is degraded. When the number-average particle diameter exceeds 300 nm, the resin particles are excessively large relative to the toner particle diameter, and this degrades dispersibility in the toner particles. The nucleating agent function of the specified resin particles is assumed to emerge as the crystals of the crystalline resin grow from the particle surfaces as starting points; thus, degraded dispersibility in the toner particles causes crystal domain segregation and degrades the effect of increasing the solidification speed.

The number-average particle diameter of the specified resin particles is measured by using a transmission electron microscope (TEM).

For example, JEM-2100 plus produced by JEOL Ltd., can be used as the transmission electron microscope.

The method for measuring the number-average particle diameter of the specified resin particles will now be described in detail.

First, toner particles are sliced with a microtome into a thickness of about 0.1 μm. Sections of the toner particles are photographed with a transmission electron microscope at a magnification of 10000×, and the equivalent circle diameter of each of one hundred specified resin particles dispersed in the toner particles is calculated from the cross-sectional area. The 50% diameter (D50p) of the number-based cumulative frequency of the obtained equivalent circle diameters is assumed to be the number-average particle diameter of the specified resin particles.

The amount of the specified resin particles contained relative to the entire toner particles is preferably 2 mass % or more and 30 mass % or less, more preferably 5 mass % or more and 25 mass % or less, and yet more preferably 8 mass % or more and 20 mass % or less.

When the amount of the specified resin particles contained relative to the entire toner particles is 2 mass % or more and 30 mass % or less, the toner more easily exhibits elasticity.

An example of the specified resin particles is a resin obtained by radical polymerization of a styrene monomer and a (meth)acrylic acid monomer described below.

Examples of the styrene monomer include styrene, a-methylstyrene, vinylnaphthalene, alkyl-substituted styrenes having alkyl chains such as 2-methylstyrene, 3-methylstyrene, 4-methylstyrene, 2-ethylstyrene, 3-ethylstyrene, and 4-ethylstyrene, halogen-substituted styrenes such as 2-chlorostyrene, 3-chlorostyrene, and 4-chlorostyrene, and fluorine-substituted styrenes such as 4-fluorostyrene and 2,5-difluorostyrene. Among these, styrene and α-methylstyrene are preferable.

Examples of the (meth)acrylic acid monomer include (meth)acrylic acid, n-methyl (meth)acrylate, n-ethyl (meth)acrylate, n-propyl (meth)acrylate, n-butyl (meth)acrylate, n-pentyl (meth)acrylate, n-hexyl (meth)acrylate, n-heptyl (meth)acrylate, n-octyl (meth)acrylate, n-decyl (meth)acrylate, n-dodecyl (meth)acrylate, n-lauryl (meth)acrylate, n-tetradecyl (meth)acrylate, n-hexadecyl (meth)acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, isooctyl (meth)acrylate, 2-ethylhexyl (meth)acrylate, phenyl (meth)acrylate, biphenyl (meth)acrylate, diphenylethyl (meth)acrylate, t-butylphenyl (meth)acrylate, terphenyl (meth)acrylate, cyclohexyl (meth)acrylate, t-butylcyclohexyl (meth)acrylate, dimethylaminoethyl (meth)acrylate, diethylaminocthyl (meth)acrylate, methoxyethyl (meth)acrylate, 2-hydroxyethyl (meth)acrylate, β-carboxyethyl (meth)acrylate, (meth)acrylonitrile, and (meth)acrylamide. Among these, n-butyl (meth)acrylate and β-carboxyethyl (meth)acrylate are preferable.

Examples of the crosslinking agent for crosslinking the resin in the crosslinked resin particles include aromatic polyvinyl compounds such as divinylbenzene and divinylnaphthalene; polyvinyl esters of aromatic polycarboxylic acids such as divinyl phthalate, divinyl isophthalate, divinyl terephthalate, divinyl homophthalate, divinyl trimesate, trivinyl trimesate, divinyl naphthalene dicarboxylate, and divinyl biphenylcarboxylate; divinyl esters of nitrogen-containing aromatic compounds such as divinyl pyridinedicarboxylate; vinyl esters of unsaturated heterocyclic compound carboxylic acids such as vinyl pyromutate, vinyl furoate, vinyl pyrrole-2-carboxylate, and vinyl thiophenecarboxylate; di(meth)acrylic acid esters of linear polyhydric alcohols such as butanediol di(meth)acrylate, hexanediol di(meth)acrylate, octanediol di(meth)acrylate, nonanediol di(meth)acrylate, decanediol di(meth)acrylate, and dodecanediol di(meth)acrylate; (meth)acrylic acid esters of branched and substituted polyhydric alcohols such as neopentyl glycol dimethacrylate and 2-hydroxy-1,3-diacryloxypropane; and polyvinyl esters of polycarboxylic acids such as polyethylene glycol di(meth)acrylate, polypropylene polyethylene glycol di(meth)acrylates, divinyl succinate, divinyl fumarate, divinyl maleate, divinyl diglycolate, vinyl itaconate, divinyl itaconate, divinyl acetonedicarboxylate, divinyl glutarate, divinyl 3,3′-thiodipropionate, divinyl trans-aconitate, trivinyl trans-aconitate, divinyl adipate, divinyl pimelate, divinyl suberate, divinyl azelate, divinyl sebacate, divinyl dodecanedioate, and divinyl brassylate. These crosslinking agents may be used alone or in combination.

Among these, a difunctional alkyl acrylate having an alkylene chain having 6 to 12 carbon atoms may be used as the crosslinking agent. When the number of carbon atoms in the alkylene chain is within the aforementioned range, the elasticity of the crosslinked resin particles can be controlled to be within a particular range. When the number of carbon atoms is less than 6, the crosslinking density is high, the distance between the crosslinking points shortens, the elasticity of the resin particles increases, the elasticity of the toner image is improved, and deformation of images when recording media having images formed thercon are stacked on top of each other is reduced; however, during the toner particle fixing step, the elasticity becomes excessively high, and fixability is degraded. When the number of carbon atoms exceeds 12, the crosslinking density is low, the distance between the crosslinking points increases, the elasticity of the resin particles decreases, and the effect of suppressing image deformation when recording media having images formed thereon are stacked on top of each other is degraded.

From the viewpoint of adjusting the crosslinking density to be within an appropriate range, the number of carbon atoms in the alkylene chain in the difunctional alkyl acrylate is preferably 6 or more, more preferably 6 or more and 12 or less, and yet more preferably 8 or more and 12 or less. More specific examples of the difunctional alkyl acrylate include 1,6-hexanediol acrylate, 1,6-hexanediol methacrylate, 1,8-octanediol diacrylate, 1,8-octanediol dimethacrylate, 1,9-nonanediol diacrylate, 1,9-nonanediol dimethacrylate, 1,10-decanediol diacrylate, 1,10-decanediol dimethacrylate, 1,12-dodecanediol diacrylate, and 1,12-dodecanediol dimethacrylate, and, among these, 1,10-decanediol diacrylate and 1,10-decanediol dimethacrylate are preferable.

### Coloring Agent

Examples of the coloring agent include various pigments such as carbon black, chrome yellow, hansa yellow, benzidine yellow, threne yellow, quinoline yellow, pigment yellow, permanent orange GTR, pyrazolone orange, vulcan orange, watchung red, permanent red, brilliant carmine 3B, brilliant carmine 6B, dupont oil red, pyrazolone red, lithol red. rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; and dyes such as acridine dyes, xanthene dyes, azo dyes, benzoquinone dyes, azine dyes, anthraquinone dyes, thioindigo dyes, dioxazine dyes, thiazine dyes, azomethine dyes, indigo dyes, phthalocyanine dyes, aniline black dyes, polymethine dyes, triphenylmethane dyes, diphenylmethane dyes, and thiazole dyes.

These coloring agents may be used alone or in combination.

The coloring agent may be surface-treated as necessary or may be used in combination with a dispersing agent. Two or more coloring agents may be used in combination.

The amount of the coloring agent contained relative to the entire toner particles is preferably 1 mass % or more and 30 mass % or less and more preferably 3 mass % or more and 15 mass % or less.

### Releasing Agent

Examples of the releasing agent include hydrocarbon wax; natural wax such as carnauba wax, rice wax, and candelilla wax; synthetic or mineral or petroleum wax such as montan wax; and ester wax such as fatty acid esters and montanic acid esters. The releasing agent is not limited to these.

The melting temperature of the releasing agent is preferably 50° C. or higher and 110° C. or lower and more preferably 60° C. or higher and 100° C. or lower.

The melting temperature is determined from a DSC curve obtained by differential scanning calorimetry (DSC) according to “Melting peak temperature” described in the method for determining the melting temperature in JIS K 7121-1987 “Testing Methods for Transition Temperatures of Plastics”.

The amount of the releasing agent contained relative to the entire toner particles is preferably 1 mass % or more and 20 mass % or less and more preferably 5 mass % or more and 15 mass % or less.

### Other Additives

Examples of the other additives include known additives such as magnetic bodies, charge controllers, and inorganic powders. These additives are contained in the toner particles as internal additives.

### Properties of Toner Particles, Etc.

The toner particles may have a single layer structure or a core-shell structure constituted by a core (core particle) and a coating layer (shell layer) covering the core.

Here, the toner particles having a core-shell structure may be constituted by, for example, a core containing a binder resin and other optional additives such as a coloring agent and a releasing agent, and a coating layer containing a binder resin.

The volume-average particle diameter (D50v) of the toner particles is preferably 2 um or more and 10 μm or less and more preferably 4 μm or more and 8 μm or less.

Various average particle diameters and various particle size distribution indices of the toner particles are measured by using COULTER MULTISIZER II (produced by Beckman Coulter Inc.) and ISOTON-II (produced by Beckman Coulter Inc.) as the electrolyte.

In measuring, a 0.5 mg or more and 50 mg or less of a measurement sample is added to 2 mL of a 5% aqueous solution of a surfactant (for example, sodium alkylbenzene sulfonate) serving as a dispersing agent. The resulting mixture is added to 100 mL or more and 150 mL or less of the electrolyte.

The electrolyte solution containing the suspended sample is dispersed for 1 minute with an ultrasonic dispersing machine, and the particle size distribution of particles having a particle diameter in the range of 2 μm or more and 60 μm or less is measured by using COULTER MULTISIZER II with an aperture having a diameter of 100 μm. The number of sampled particles is 50,000.

On the basis of the measured particle size distribution, the volume and the number are plotted versus particle size ranges (channels) from the small diameter side to draw cumulative distributions, and then the particle diameters at 16% accumulation are defined as a volume particle diameter D16v and a number particle diameter D16p, the particle diameters at 50% accumulation are defined as a volume average particle diameter D50v and accumulated number average particle diameter D50p, and the particle diameters at 84% accumulation are defined as a volume particle diameter D84v and a number particle diameter D84p.

Then the volume particle size distribution index (GSDv) and the number particle distribution index (GSDp) are calculated as (D84v/D16v)^{1/2} and (D84p/D16p)^{1/2}, respectively, from these values.

The average circularity of the toner particles is preferably 0.94 or more and 1.00 or less and more preferably 0.95 or more and 0.98 or less.

The average circularity of the toner particles is determined from (equivalent circle perimeter)/(perimeter) [(perimeter of a circle having the same projection area as the particle image)/(perimeter of a particle projection image)]. A specific measurement method is as follows.

First, toner particles to be measured are sampled by suction, are allowed to form a flat flow, and are imaged to obtain still images by instantaneous strobe light emission, and these particle images are analyzed by a flow-type particle image analyzer (FPIA-3000 produced by Sysmex Corporation) to determine the average circularity. In determining the average circularity, 3500 particles are sampled.

When the toner contains an external additive, the toner (developer) to be measured is dispersed in surfactant-containing water, and then ultrasonically treated to obtain toner particles from which the external additive have been removed.

In measuring the dynamic viscoelasticity of the components in the toner particles other than the specified resin particles during heating at 2° C./min, the storage modulus G′(t) at 50° C. may be 1×10⁸ Pa or higher, and the temperature at which the storage modulus G′(t) reaches below 1×10⁵ Pa may be 70° C. or higher and 90° C. or lower.

When the dynamic viscoelasticity of the components in the toner particles other than the specified resin particles has such features, the heat resistance storage property of the toner is improved compared to when the storage modulus G′(t) at 50° C. is less than 1×10⁸ Pa, the heat resistance storage property of the toner is improved compared to when the temperature at which the storage modulus G′(t) reaches below 1×10⁵ Pa is lower than 70° C., and the fixability is improved compared to when this temperature is higher than 90° C.

The storage modulus G′(t) of the components of the toner particles other than the specified resin particles is measured as follows.

Specifically, first, the specified resin particles are removed from the toner particles to obtain only the remaining components, and the remaining components are pelletized at 25° C. with a press forming machine to prepare measurement samples. An example of the method for obtaining only the remaining components other than the specified resin particles from the toner particles is a method that involves immersing the toner particles in a solvent that dissolves the binder resin but not the specified resin particles to extract only the remaining components. The obtained measurement sample is placed between parallel plates having a diameter of 8 mm and heated under a strain of 0.1% to 100% at a measurement temperature elevation speed of 2° C./min from 30° C. to 150° C., and the storage modulus G′ is obtained by dynamic viscoelasticity measurement under the following conditions.

### Measurement Conditions

Measurement instrument: rheometer ARES-G2 (produced by TA Instruments)
Measurement fixture: 8 mm parallel plates
Gap: adjusted to 3 mm
Frequency: 1 Hz

In measuring the dynamic viscoelasticity of components in the toner particles other than the specified resin particles during heating at 2° C./min, the storage modulus G′(t) at 50° C. is more preferably 1×10⁸ Pa or more and 1×10⁹ Pa or less and yet more preferably 1×10⁸ Pa more and 5×10⁸ Pa or less.

In measuring the dynamic viscoelasticity of the components in the toner particles other than the specified resin particles during heating at 2° C./min, the temperature at which the storage modulus G′(t) reaches below 1×10⁵ Pa is more preferably 70° C. or higher and 80° C. or lower and yet more preferably 70° C. or higher and 75° C. or lower.

### External Additive

An example of the external additive is inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO·SiO₂, K₂O·(TiO₂)n, Al₂O₃·2O SiO₂, CaCO₃, MgCO₃, BaSO₄, and MgSO₄.

The surfaces of the inorganic particles serving as an external additive may be hydrophobized. Hydrophobizing involves, for example, immersing inorganic particles in a hydrophobizing agent. The hydrophobizing agent may be any, and examples thereof include silane coupling agents, silicone oils, titanate coupling agents, and aluminum coupling agents. These agents may be used alone or in combination.

The amount of the hydrophobizing agent relative to 100 parts by mass of the inorganic particles is, for example, usually 1 part by mass or more and 10 parts by mass or less.

Other examples of the external additives include resin particles (resin particles of polystyrene, polymethyl methacrylate (PMMA), melamine resin, etc.), and cleaning activating agents (for example, particles higher fatty acid metal salts such as zinc stearate and fluorine polymers).

The amount of the external additive relative to the toner particles is preferably 0.01 mass % or more and 5 mass % or less and more preferably 0.01 mass % or more and 2.0 mass % or less.

### Properties of Toner

In differential scanning calorimetry, the toner of the present exemplary embodiment has a crystalline resin-derived endothermic peak temperature Tc of 60° C. or higher and 75° C. or lower, and, from the viewpoint of low-temperature fixability, preferably has a crystalline resin-derived endothermic peak temperature Tc of 65° C. or higher and 72° C. or lower and more preferably 67° C. or higher and 70° C. or lower.

The crystalline resin-derived endothermic peak temperature Tc is measured as follows.

Into a differential scanning calorimeter equipped with an automatic tangent processing system (DSC-60A produced by Shimadzu Corporation), 10 mg of the toner to be measured is loaded, heated at a heating rate of 10° C./min from room temperature)(25° C. to 150° C., and retained at 150° C. for 5 minutes to obtain a thermal spectrum (DSC curve) during the heating process. The endothermic peak derived from the crystalline resin is identified from the thermal spectrum (DSC curve), and the local minimum value of the endothermic peak is assumed to be the endothermic peak temperature Te of the crystalline resin.

According to the toner of this exemplary embodiment, the ratio (Q1/Q2) of a heat absorption Q1 of the crystalline resin calculated by performing differential scanning calorimetry on the toner that has been melted at 150° C., then cooled to a temperature 10° C. lower than the endothermic peak temperature Tc, and then retained thereat for 1 minute, to a heat absorption Q2 of the crystalline resin calculated by performing differential scanning calorimetry on the toner that has been melted at 150° C., then cooled to a temperature 10° C. lower than the endothermic peak temperature Tc, and then retained thereat for 30 minutes is 0.15 or more, and, from the viewpoint of reducing blocking, the ration (A1/A2) is preferably 0.2 or more and more preferably 0.5 or more.

The upper limit of the ratio (Q1/Q2) may be 1.0.

From the viewpoint of reducing blocking, the heat absorption Q1 is preferably 2 J/g or more and 12 J/g or less, more preferably 4 J/g or more and 10 J/g or less, and yet more preferably 5 J/g or more and 9 J/g or less.

The heat absorptions Q1 and Q2 are measured as follows.

### Procedure for Measuring Q1

Into a differential scanning calorimeter equipped with an automatic tangent processing system (DSC-60A produced by Shimadzu Corporation), 10 mg of the toner to be measured is loaded and heated to 150° C. to melt. Then the sample is cooled to a temperature 10° C. lower than the endothermic peak temperature and retained thereat for 1 minute. Next, the sample is heated at a heating rate of 10° C./min from the temperature 10° C. lower than Tc to 150° C. to obtain a thermal spectrum (DSC curve) in the heating process. The endothermic peak derived from the crystalline resin is identified from the thermal spectrum (DSC curve), and the area of the endothermic peak derived from the crystalline resin is calculated as the heat absorption Q1. The area of the endothermic peak is an area of the region surrounded by the base line and the endothermic peak as determined from the endothermic peak derived from the crystalline resin in accordance with ASTM D3418-8 (2008).

### Procedure for Measuring Q2

Q2 is measured as with Q1 except that the retention time after cooling to a temperature 10° C. lower than the endothermic peak temperature Tc is changed to 30 minutes.

The maximum value of the loss coefficient tan δ of the toner of the present exemplary embodiment at 50° C. or higher and 70° C. or lower is less than 1.2 and is preferably 1.1 or less from the viewpoint of reducing blocking.

The minimum value of the loss coefficient tan δ at 50° C. or higher and 70° C. or lower is 0.5 or more and is preferably 0.8 or more.

The loss coefficient tan δ of the toner at 50° C. or higher and 70° C. or lower is a value measured with a rheometer.

For example, ARES-G2 (product name) produced by TA Instruments can be used as the rheometer.

The procedure for measuring the loss coefficient tan δ(t) of the toner at 50° C. or higher and 70° C. or lower will now be specifically described.

The toner to be measured is formed at 25° C. by using a press forming machine to prepare a tablet-shaped (thickness: 3.0 mm, diameter: 8.0 mm, disk shape) measurement sample. Then the loss coefficient is measured by using this measurement sample and the rheometer under the following conditions.

The loss coefficient measured when the measurement sample is at 50° C. or higher and 70° C. or lower is assumed to be the loss coefficient tan δ(t) of the toner at 50° C. or higher and 70° C. or lower.

### Conditions

Measurement instrument: rheometer ARES (produced by TA Instruments)
Measurement fixture: 8 mm parallel plates
Gap: adjusted to 3 mm
Frequency: 1 Hz

The storage modulus G′ of the toner at 75° C. during a heating process is preferably 2×10⁴ Pa or more and 1×10⁶ Pa or less and more preferably 2×10⁴ Pa or more and 5×10⁵ Pa or less.

When the storage modulus G′ of the toner at 75° C. during a heating process is less than 2×10⁴ Pa, the viscosity of the toner fixed to the recording medium is low, and images are likely to undergo blocking when the recording media having images formed thereon are stacked on top of each other. When the storage modulus G′ exceeds 1×10⁶ Pa, the melting property of the toner during fixing is degraded, and fixability is degraded; thus, the storage modulus G″ is preferably controlled to be within the aforementioned range of 2×10⁴ Pa or more and 1×10⁶ Pa or less.

The storage modulus G′ of the toner at 75° C. is measured as follows.

A disk-shaped sample having a thickness of 2 mm and a diameter of 8 mm is prepared by applying pressure to the toner to be measured and is used as the measurement sample. The obtained measurement sample, which is a disk-shaped sample, is placed between parallel plates having a diameter of 8 mm and heated under a strain of 0.1 to 100% from a measurement temperature of 23° C. to 80° C. at a heating rate of 2° C./min, and the dynamic viscoelasticity is measured under the following conditions. The storage modulus G′ at 75° C. is then determined from the curves of the storage modulus and the loss elastic modulus obtained by the measurement.

### Measurement Conditions

Measurement instrument: rheometer ARES-G2 (produced by TA Instruments)
Gap: adjusted to 3 mm
Frequency: 1 Hz

### Toner Production Method

Next, a toner production method according to an exemplary embodiment is described.

The toner according to the exemplary embodiment is obtained by externally adding an external additive to the toner particles after production of the toner particles.

The toner particles may be produced by a dry method (for example, a kneading and pulverizing method) or a wet method (for example, an aggregation and coalescence method, a suspension polymerization method, or a dissolution and suspension method). The method for producing the toner particles may be any, and any known method may be employed.

Among these methods, the aggregation and coalescence method may be used to obtain toner particles.

Specifically, for example, the toner particles are produced as follows by the aggregation and coalescence method.

Toner particles are produced through the following steps: a step of preparing a binder resin particle dispersion in which binder resin particles that serve as a binder resin are dispersed and a specified resin particle dispersion in which resin particles that serve as specified resin particles are dispersed (dispersion preparation step); a step of forming aggregated particles by allowing the binder resin particles and the specified resin particles (and other particles as necessary) in a dispersion (or in a dispersion containing a dispersion of other particles as necessary) (aggregated particle forming step); and a step of forming toner particles by heating the aggregated particle dispersion in which the aggregates particles are dispersed so as to fuse and coalesce the aggregated particles (fusing and coalescing step).

The respective steps will now be described in detail.

In the description below, a method for obtaining toner particles that contain a releasing agent and a coloring agent is described; however, the releasing agent and the coloring agent are optional. Naturally, any additives other than the releasing agent and the coloring agent may be used.

### Dispersion Preparation Step

First, a binder resin particle dispersion in which binder resin particles that serve as a binder resin are dispersed, a coloring agent particle dispersion in which coloring agent particles are dispersed, and a releasing agent dispersion in which releasing agent particles are dispersed are prepared.

Here, the binder resin particle dispersion is prepared by, for example, dispersing binder resin particles in a dispersing medium by using a surfactant.

An example of the dispersing medium used in the binder resin particle dispersion is an aqueous medium.

Examples of the aqueous medium include water such as distilled water and ion exchange water, and alcohols. These may be used alone or in combination.

Examples of the surfactant include anionic surfactants such as sulfate esters, sulfonates, phosphate esters, and soaps; cationic surfactants such as amine salts and quaternary ammonium salts; and nonionic surfactants such as polyethylene glycol, alkyl phenol-ethylene oxide adducts, and polyhydric alcohols. Among these, anionic surfactants and cationic surfactants are particularly preferable. The nonionic surfactants may be used in combination with anionic surfactants or cationic surfactants.

These surfactants may be used alone or in combination.

Examples of the method for dispersing binder resin particles in a dispersing medium to prepare a binder resin particle dispersion include typical dispersing methods that use a rotational shear-type homogenizer, or a mill that uses media such as a ball mill, a sand mill, or a dyno mill. Depending on the type of the binder resin particles, the binder resin particles may be dispersed in a binder resin particle dispersion by a phase inversion emulsification method.

The phase inversion emulsification method is a method that involves dissolving a resin to be dispersed in a hydrophobic organic solvent that can dissolve the resin, adding a base to the organic continuous phase (O phase) to neutralize, and then adding an aqueous medium (W phase) to the resulting mixture to perform W/O-to-O/W phase conversion and disperse the resin into particles in the aqueous medium.

The volume-average particle diameter of the binder resin particles to be dispersed in the binder resin particle dispersion is preferably 0.01 μm or more and 1 μm or less, more preferably 0.08 μm or more and 0.8 μm or less, and yet more preferably 0.1 μm or more and 0.6 μm or less.

The volume-average particle diameter of the binder resin particles is determined by using a particle size distribution obtained by measurement with a laser waveform-type particle size distribution meter (for example, LS-13320 produced by Beckman Coulter Inc.), drawing a cumulative distribution with respect to volume from the small-diameter-side relative to the divided particle size ranges (channels), and assuming the particle diameter at 50% accumulation relative to all particles as the volume-average particle diameter D50v. Note that the volume-average particle diameter of other particles in other dispersions is also measured in the same manner.

The amount of the binder resin particles contained in the binder resin particle dispersion is, for example, preferably 5 mass % or more and 50 mass % or less and more preferably 10 mass % or more and 40 mass % or less.

The coloring agent particle dispersion and the releasing agent particle dispersion are also prepared in the same manner as the binder resin particle dispersion. That is, the volume-average particle diameter of the particles, the dispersing medium, the dispersing method, and the amount of the particles contained described for the binder resin particle dispersion also apply to the coloring agent particles dispersed in the coloring agent particle dispersion and the releasing agent particles dispersed in the releasing agent particle dispersion.

### Preparation of Specified Resin Particle Dispersion

A specified resin particle dispersion is prepared by, for example, a known method such as an emulsion polymerization method, a melt kneading method that uses a Banbury mixer, a kneader, or the like, a suspension polymerization method, or an atomization drying method; however, an emulsion polymerization method is preferable.

From the viewpoint of adjusting the loss coefficient to be within a particular range, a styrene monomer and a (meth)acrylic acid monomer may be used as the monomers, and polymerization may be performed in the presence of a crosslinking agent.

Furthermore, in producing specified resin particles, emulsion polymerization may be performed multiple times.

The method for producing specified resin particles will now be described in specific details.

A method for preparing a specified resin particle dispersion may include:
a step of obtaining an emulsion that contains monomers, a crosslinking agent, a surfactant, and water (emulsion preparation step); and
a step of adding a polymerization initiator to the emulsion and heating the resulting mixture to polymerize the monomers (emulsion polymerization step).

### Emulsion Preparation Step

In this step, an emulsion that contains monomers, a crosslinking agent, a surfactant, and water is obtained.

The emulsion may be obtained by emulsifying the monomers, the crosslinking agent, the surfactant, and water by using emulsifying equipment.

Examples of the emulsifying equipment include rotary stirrers equipped with a propeller-type, anchor-type, paddle-type, or turbine-type stirring blade, a static-type mixing machine such as a static mixer, a rotor-stator-type emulsifying machine such as a homogenizer or a clear mix, a mill-type emulsifying machine equipped with a milling function, a high-pressure emulsifying machine such as Manton-Gaulin high-pressure homogenizer, a high-pressure nozzle-type emulsifying machine that generates cavitations under high pressure, a high-pressure collision-type emulsifying machine that applies shear force by liquid-liquid collision at high pressure such as a microfluidizer, an ultrasonic emulsifying machine that ultrasonically generates cavitations, and membrane emulsifying machine that performs uniform emulsifying through fine pores.

A styrene monomer and a (meth)acrylic acid monomer may be used as the monomers. The crosslinking agent described above is used as the crosslinking agent.

Examples of the surfactant include anionic surfactants such as sulfate esters, sulfonates, phosphate esters, and soaps; cationic surfactants such as amine salts and quaternary ammonium salts; and nonionic surfactants such as polyethylene glycol, alkyl phenol-ethylene oxide adducts, and polyhydric alcohols. The nonionic surfactants may be used in combination with anionic surfactants or cationic surfactants. Among these, anionic surfactants are preferable. These surfactants may be used alone or in combination.

The emulsion may contain a chain transfer agent. The chain transfer agent may be any and can be a thiol component-containing compound. Specific examples thereof include alkyl mercaptans such as hexyl mercaptan, heptyl mercaptan, octyl mercaptan, nonyl mercaptan, decyl mercaptan, and dodecyl mercaptan.

### Emulsion Polymerization Step

In this step, a polymerization initiator is added to the emulsion and the resulting mixture is heated to polymerize the monomers (emulsion polymerization step).

Here, during polymerization, the emulsion (reaction solution) containing the polymerization initiator may be stirred with a stirrer.

Examples of the stirrer include rotary stirrers equipped with propeller-type, anchor-type, paddle-type, or turbine-type stirring blades.

Ammonium persulfate may be used as the polymerization initiator.

In the emulsion polymerization step, a surfactant may be added when the monomer conversion rate has reached 95% or higher. Adding a surfactant when the monomer conversion rate has reached 95% or higher places the surfactant on the surfaces of the resin particles and increases the dispersibility of the resin particles. As a result, aggregation of the resin particles in the toner particles is reduced, and the dispersibility is improved. If the surfactant is added at a conversion rate lower than 95%, the surfactant penetrates into the resin particles and the effect of improving the dispersibility of the resin particles is diminished. The conversion rate is measured as follows.

The specified resin particle dispersion during the polymerization reaction is sampled from the inside of the flask, and the solid content thereof is measured using a water meter (MX50 produced by A & D Company Limited). The observed solid content is divided by the feed solid content of the specified resin particle dispersion, and the result is assumed to be the conversion rate.

The surfactant described above can be used as the surfactant.

The specified resin particle dispersion may be produced though the aforementioned steps.

### Aggregated Particle Forming Step

Next, the binder resin particle dispersion, the coloring agent particle dispersion, the releasing agent particle dispersion, and the resin particle dispersion are mixed.

Next, in the mixed dispersion, the binder resin particles, the coloring agent particles, the releasing agent particles, and the resin particles are caused to undergo hetero-aggregation to form aggregated particles that have a diameter close to the target diameter of the toner particles and contain the binder resin particles, the coloring agent particles, the releasing agent particles, and the resin particles.

Specifically, for example, an aggregating agent is added to the mixed dispersion, the pH of the mixed dispersion is adjusted to acidic (for example, a pH of 2 or more and 5 or less), a dispersion stabilizer is added as necessary, and the resulting mixture is heated to a temperature near the glass transition temperature of the resin particles (specifically, for example, to a temperature 30° ° C.to 10° C. lower than the glass transition temperature of the resin particles) so as to aggregate the particle dispersed in the mixed dispersion and thereby form aggregated particles.

In the aggregated particle forming step, for example, the aggregating agent may be added to the mixed dispersion while stirring with a rotary shear homogenizer at room temperature (for example, 25° C.), the pH of the mixed dispersion may be adjusted to acidic (for example, a pH of 2 or more and 5 or less), the dispersion stabilizer may be added as necessary, and then the aforementioned heating may be conducted.

Examples of the aggregating agent include surfactants that have a polarity opposite to the surfactant used as the dispersing agent added to the mixed dispersion, inorganic metal salts, and divalent or higher valent metal complexes. In particular, when a metal complex is used as the aggregating agent, the amount of the surfactant used is decreased, and the charge properties are improved.

An additive that forms a complex or a similar bond with the metal ions in the aggregating agent may be used as necessary. This additive may be a chelating agent.

Examples of the inorganic metal salt include metal salts such as calcium chloride, calcium nitrate, barium chloride, magnesium chloride, zinc chloride, aluminum chloride, and aluminum sulfate, and inorganic metal salt polymers such as polyaluminum chloride, polyaluminum hydroxide, and calcium polysulfide.

A water-soluble chelating agent may be used as the chelating agent. Examples of the chelating agent include oxycarboxylic acids such as tartaric acid, citric acid, and gluconic acid, iminodiacetic acid (IDA), nitrilotriacetic acid (NTA), and ethylenediaminetetraacetic acid (EDTA).

The amount of the chelating agent relative to 100 parts by mass of the resin particles is preferably 0.01 parts by mass or more and 5.0 parts by mass or less and more preferably 0.1 parts by mass or more and 3.0 parts by mass or less.

### Fusing and Coalescing Step

Next, the aggregated particle dispersion in which the aggregated particles are dispersed is heated to, for example, a temperature higher than the glass transition temperature of the binder resin particles (for example, a temperature 10 to 30° C. higher than the glass transition temperature of the binder resin particles) to fuse and coalesce the aggregated particles and to thereby form toner particles.

The toner particles are obtained through the above-described steps.

Alternatively, the toner particles may be produced by performing, after the aggregated particle dispersion in which the aggregated particles are dispersed is obtained, a step of forming second aggregated particles by mixing the aggregated particle dispersion with a binder resin particle dispersion and a releasing agent particle dispersion, and then aggregating the particles so that the binder resin particles and the releasing agent particles attach to the surfaces of the aggregated particles, and a step of forming core-shell structure toner particles by heating the second aggregated particle dispersion in which the second aggregated particles are dispersed so as to fuse and coalesce the second aggregated particles.

### Annealing Step

The toner according to the exemplary embodiment may be subjected to an annealing (heat treatment) step after the fusing and coalescing step.

The annealing step is, for example, a step of heating the obtained toner particles to a temperature of 40° C. or higher and 70° ° C.or lower and retaining the temperature thereat for 0.5 hours or longer and 15 hours or shorter.

### Other Steps

After completion of the annealing step, the toner particles formed in the solution are subjected to a known washing step, a known solid-liquid separation step, and a known drying step to obtain dry toner particles.

The washing step may involve thorough substitution washing with ion exchange water from the viewpoint of chargeability. The solid-liquid separation step is not particularly limited and may involve suction filtration, pressure filtration, or the like. The drying step is also not particularly limited and may involve freeze-drying, air stream drying, flow-drying, vibrational flow drying, or the like, from the viewpoint of productivity.

The toner of the exemplary embodiment is produced by mixing the obtained dry toner particles with an external additive and mixing the resulting mixture. Mixing may be performed by using, for example, a V blender, a Henschel mixer, a Loedige mixer, or the like. If necessary, coarse particles may be removed by using a vibrating sifter, an air sifter, or the like.

### Electrostatic Charge Image Developer

The electrostatic charge image developer of the exemplary embodiment contains at least the toner of the present exemplary embodiment.

The electrostatic charge image developer of the exemplary embodiment may be a one-component developer that contains only the toner of the present exemplary embodiment or a two-component developer containing the toner and a carrier.

The carrier may be any and may be a known carrier, for example. Examples of the carrier include a coated carrier obtained by covering a surface of a core formed of a magnetic powder with a coating resin; a magnetic powder-dispersed carrier in which a magnetic powder is dispersed and blended in a matrix resin; and a resin-impregnated carrier in which a porous magnetic powder is impregnated with a resin.

The magnetic powder-dispersed carrier and the resin-impregnated carrier may each be constituted by a core formed of a constituent particle of the carrier, and a coating resin covering the core.

Examples of the magnetic powder include magnetic metals such as iron, nickel, and cobalt, and magnetic oxides such as ferrite and magnetite.

Examples of the coating resin and the matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylate copolymer, an organosiloxane bond-containing straight silicone resin and modified products thereof, a fluororesin, polyester, polycarbonate, phenolic resin, and epoxy resin.

The coating resin and the matrix resin may each contain other additives such as conductive particles.

Examples of the conductive particles include particles of metals such as gold, silver, and copper, and particles of carbon black, titanium oxide, zinc oxide, tin oxide, barium sulfate, aluminum borate, and potassium titanate.

Here, an example of the method for coating the surface of the core with a resin include a method that involves coating the surface of the core with a coating layer-forming solution prepared by dissolving a coating resin and, if needed, various additives in an appropriate solvent. The solvent is not particularly limited, and may be selected in view of the type of the coating resin used, application suitability, etc.

Specific examples of the resin coating method include a dipping method that involves dipping a core in a coating layer-forming solution, a spraying method that involves spraying a coating layer-forming solution onto the surface of the core, a flow bed method that involves spraying a coating layer-forming solution while the core floats on flowing air, and a kneader coater method that involves mixing the core for the carrier and a coating layer-forming solution in a kneader coater and removing the solvent.

The toner-to-carrier mixing ratio (mass ratio) in the two-component developer is preferably 1:100 to 30:100, and more preferably 3:100 to 20:100.

### Image Forming Apparatus and Image Forming Method

An image forming apparatus and an image forming method according to exemplary embodiments will now be described.

An image forming apparatus according to an exemplary embodiment includes an image bearing member, a charging unit that charges a surface of the image bearing member, an electrostatic charge image forming unit that forms an electrostatic charge image on the charged surface of the image bearing member, a developing unit that stores an electrostatic charge image developer and develops the electrostatic charge image on the surface of the image bearing member into a toner image by using the electrostatic charge image developer, a transfer unit that transfers the toner image on the surface of the image bearing member onto a surface of a recording medium, and a fixing unit that fixes the transferred toner image on the surface of the recording medium. The electrostatic charge image developer of the present exemplary embodiment is employed as the electrostatic charge image developer.

The image forming apparatus of the present exemplary embodiment is used to implement an image forming method (the image forming method of the present exemplary embodiment) that involves a charging step of charging a surface of an image bearing member, an electrostatic charge image forming step of forming an electrostatic charge image on the charged surface of the image bearing member, a developing step of developing the electrostatic charge image on the surface of the image bearing member into a toner image by using the electrostatic charge image developer of the exemplary embodiment, a transfer step of transferring the toner image on the surface of the image bearing member onto a surface of a recording medium, and a fixing step of fixing the transferred toner image on the surface of the recording medium.

The image forming apparatus of the present exemplary embodiment may be, for example, a known image forming apparatus such as a direct transfer type apparatus with which a toner image formed on a surface of an image bearing member is directly transferred onto a recording medium; an intermediate transfer type apparatus with which a toner image formed on a surface of an image bearing member is first transferred onto a surface of an intermediate transfer body and then the toner image on the intermediate transfer body is transferred for the second time onto a surface of a recording medium; an apparatus equipped with a cleaning unit that cleans the surface of an image bearing member after the transfer of the toner image and before charging; or an apparatus equipped with a charge erasing unit that irradiates the surface of an image bearing member with charge erasing light to remove charges after the transfer of the toner image and before charging.

When the intermediate transfer type apparatus is used, the transfer unit has a structure that includes an intermediate transfer body having a surface that receives the transfer of a toner image, a first transfer unit that performs first transfer of transferring the toner image on the surface of the image bearing member onto a surface of the intermediate transfer body, and a second transfer unit that performs second transfer of transferring the transferred toner image on the surface of the intermediate transfer body onto a surface of a recording medium.

In the image forming apparatus of the present exemplary embodiment, for example, a portion that includes the developing unit may have a cartridge structure (process cartridge) detachably attachable to the image forming apparatus. An example of the process cartridge is a process cartridge equipped with a developing unit that stores the electrostatic charge image developer of the exemplary embodiment.

Hereinafter, one example of the image forming apparatus of the exemplary embodiment is described, but this exemplary embodiment is not limiting. Only the relevant parts in the drawing are described, and descriptions for other parts are omitted.

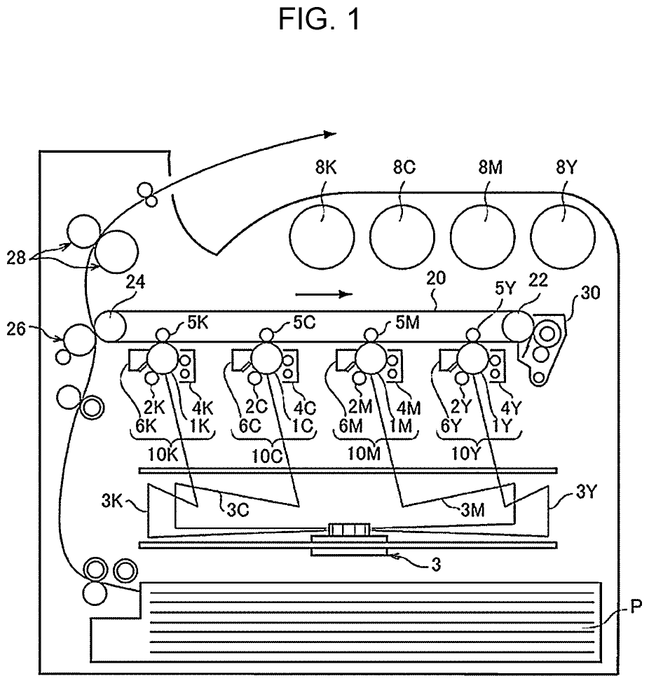

FIG. 1 is a schematic diagram illustrating an image forming apparatus according to an exemplary embodiment.

An image forming apparatus illustrated in FIG. 1 is equipped with electrophotographic first to fourth image forming units 10Y, 10M, 10C, and 10K (image forming units) that output images of respective colors, yellow (Y), magenta (M), cyan (C), and black (K), on the basis of the color separated image data. These image forming units (hereinafter may be simply referred to as “units”) 10Y, 10M, 10C, and 10K are spaced from one another by predetermined distances in the horizontal direction and arranged side-by-side. The units 10Y, 10M, 10C, and 10K may be process cartridges detachably attachable to the image forming apparatus.

An intermediate transfer belt 20 serving as an intermediate transfer body extends above all of the units 10Y, 10M, 10C, and 10K in the drawing. The intermediate transfer belt 20 is wound around a driving roll 22 and a supporting roll 24 arranged to be spaced from each other in the left-to-right direction in the drawing, and runs in the direction from the first unit 10Y toward the fourth unit 10K. The supporting roll 24 is urged to be away from the driving roll 22 by a spring or the like not illustrated in the drawing, so that a tension is applied to the intermediate transfer belt 20 wound around the two rolls. An intermediate transfer body cleaning device 30 that opposes the driving roll 22 is disposed on the image-bearing-member-side surface of the intermediate transfer belt 20.

In addition, toners of four colors, yellow, magenta, cyan, and black, are supplied from toner cartridges 8Y, 8M, 8C, and 8K to developing devices (developing units) 4Y, 4M, 4C, and 4K of the units 10Y, 10M, 10C, and 10K.

Since the first to fourth units 10Y, 10M, 10C, and 10K are identical in structure, the first unit 10Y that is disposed on the upstream side in the intermediate transfer belt running direction and forms a yellow image is described as a representative example. The parts equivalent to those of the first unit 10Y are represented by the same reference sign followed by magenta (M), cyan (C), or black (K) instead of yellow (Y), and descriptions of the second to fourth units 10M, 10C, and 10K are omitted.

The first unit 10Y includes a photoreceptor 1Y that serves as an image bearing member. The photoreceptor 1Y are surrounded by, in order of arrangement, a charging roll (one example of the charging unit) 2Y that charges a surface of the photoreceptor 1Y to a predetermined potential, an exposing device (one example of the electrostatic charge image forming unit) 3 that exposes the charged surface of the photoreceptor 1Y with a laser beam 3Y on the basis of the color-separated image signal so as to form an electrostatic charge image, a developing device (one example of the developing unit) 4Y that develops the electrostatic charge image by supplying a charged toner to the electrostatic charge image, a first transfer roll (one example of the first transfer unit) 5Y that transfers the developed toner image onto the intermediate transfer belt 20, and a cleaning device (one example of the cleaning unit) 6Y that removes the toner remaining on the surface of the photoreceptor 1Y after the first transfer.

The first transfer roll 5Y is disposed on the inner side of the intermediate transfer belt 20 and positioned to oppose the photoreceptor 1Y. Furthermore, bias power supplies (not illustrated) that apply first transfer biases are respectively connected to the first transfer rolls 5Y, 5M, 5C, and 5K. A controller not illustrated in the drawing controls each of the bias power supplies so that the transfer bias applied to the first transfer roll is variable.

Hereinafter, operation of forming a yellow image in the first unit 10Y is described.

First, before starting operation, the surface of the photoreceptor 1Y is charged by the charging roll 2Y to a potential in the range of −600 V to −800 V.

The photoreceptor 1Y is formed by stacking a photosensitive layer on a conductive (for example, volume resistivity at 20° C.: 1×10⁻⁶ Ω·cm or less) base. This photosensitive layer normally has a high resistance (a resistance of a general resin); however, once irradiated with a laser beam 3Y, the portion exposed to the laser beam exhibits a change in resistivity. Next, the charged surface of the photoreceptor 1Y is irradiated with a laser beam 3Y emitted from the exposing device 3 on the basis of the yellow image data transmitted from a controller not illustrated in the drawings. The photosensitive layer constituting the surface of the photoreceptor 1Y is irradiated with the laser beam 3Y, and an electrostatic charge image having a yellow image pattern is thereby formed on the surface of the photoreceptor 1Y.

An electrostatic charge image is an image formed on the surface of the photoreceptor 1Y as a result of charging, and is a negative latent image formed as the decrease in the resistivity of the portion of the photosensitive layer irradiated with the laser beam 3Y causes the charges to flow out from the surface of the photoreceptor 1Y while the charges in the portions not irradiated with the laser beam 3Y remain.

The electrostatic charge image formed on the photoreceptor 1Y is rotated to a predetermined developing position as the photoreceptor 1Y is run. At that developing position, the electrostatic charge image on the photoreceptor 1Y is visualized by the developing device 4Y into a toner image (developed image).

The developing device 4Y stores an electrostatic charge image developer that contains at least a yellow toner and a carrier. The yellow toner is frictionally charged by being stirred in the developing device 4Y, and is held on the developer roll (one example of the developer carrying member) while the yellow toner has charges of the same polarity (negative polarity) as the charges on the photoreceptor 1Y. As the surface of the photoreceptor 1Y passes the developing device 4Y, the yellow toner electrostatically adheres to the latent image portion from which the charges on the surface of the photoreceptor 1Y have been removed, and the latent image is developed with the yellow toner. The photoreceptor 1Y on which the yellow toner image is formed is continuously run at a predetermined speed, and the developed toner image on the photoreceptor 1Y is conveyed to a predetermined first transfer position.

Once the yellow toner image on the photoreceptor 1Y is conveyed to the first transfer position, a first transfer bias is applied to the first transfer roll 5Y, an electrostatic force acting from the photoreceptor 1Y toward the first transfer roll 5Y acts on the toner image, and the toner image on the photoreceptor 1Y is transferred onto the intermediate transfer belt 20. The transfer bias applied here has a polarity (+) opposite to the polarity (−) of the toner, and, in the first unit 10Y, for example, is controlled at +10 μA by a controller (not illustrated).

Meanwhile, the toner remaining on the photoreceptor 1Y is removed by the photoreceptor cleaning device 6Y and recovered.

The first transfer biases applied to the first transfer rolls 5M, 5C, and 5K of the second unit 10M and onwards are also controlled as with the first unit.

The intermediate transfer belt 20, onto which a yellow toner image is transferred in the first unit 10Y, sequentially passes the second to fourth units 10M, 10C, and 10K, and toner images of respective colors are stacked on top of each other to perform multilayer transfer.

After the multilayer transfer of toner images of four colors through the first to fourth units, the intermediate transfer belt 20 reaches a second transfer portion constituted by the intermediate transfer belt 20, the supporting roll 24 in contact with the inner surface of the intermediate transfer belt 20, and a second transfer roll (one example of the second transfer unit) 26 disposed on the image-retaining-surface-side of the intermediate transfer belt 20. Meanwhile, a recording sheet (one example of the recording medium) P is fed, via a feeder mechanism, to a contact gap between the second transfer roll 26 and the intermediate transfer belt 20 at a predetermined timing, and a second transfer bias is applied to the supporting roll 24. The transfer bias applied here has the same polarity (−) as the polarity o(−) of the toner, an electrostatic force from the intermediate transfer belt 20 acting toward the recording sheet P acts on the toner images, and the toner images on the intermediate transfer belt 20 are transferred onto the recording sheet P. Here, the second transfer bias is determined according to the resistance of the second transfer portion detected by a resistance detection unit (not illustrated), and is controlled by voltage.

Subsequently, the recording sheet P is conveyed to a contact portion (nip portion) of a pair of fixing rolls in a fixing device (one example of the fixing unit) 28 where the toner images are fixed to the recording sheet P and a fixed image is formed.

Examples of the recording sheet P onto which the toner images are transferred include regular paper used in electrophotographic copiers and printers. Examples of the recording medium also include OHP sheets and the like in addition of the recording sheet P.

In order to further improve the smoothness of the image surface after fixing, the surface of the recording sheet P may be smooth. For example, coated paper obtained by coating the surface of regular paper with a resin or the like, art paper for printing, and the like may be used. After completion of fixing of the color image, the recording sheet P is conveyed toward a discharge portion, and a series of color image forming operation steps are completed.

### Process Cartridge and Toner Cartridge

A process cartridge according to an exemplary embodiment will now be described.

The process cartridge according to this exemplary embodiment is detachably attachable to an image forming apparatus, and includes a developing unit that stores the electrostatic charge image developer of the exemplary embodiment and develops an electrostatic charge image on a surface of an image bearing member into a toner image by using the electrostatic charge image developer.

The process cartridge of the exemplary embodiment is not limited to the aforementioned structure, and may include a developing device and, if needed, at least one unit selected from an image bearing member, a charging unit, an electrostatic charge image forming unit, transfer unit, and other units, for example.

Hereinafter, one example of the process cartridge of the exemplary embodiment is described, but this example is not limiting. Only the relevant parts in the drawing are described, and descriptions for other parts are omitted.

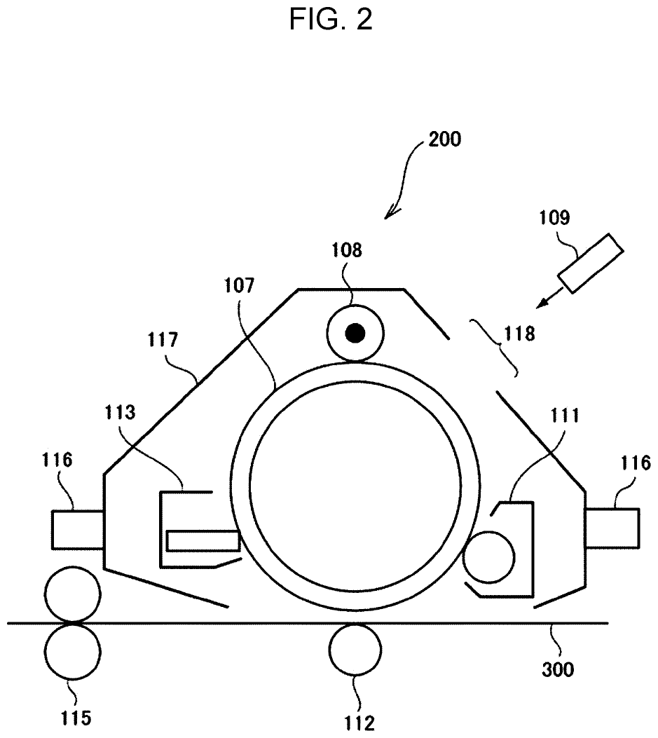

FIG. 2 is a schematic diagram illustrating a process cartridge according to an exemplary embodiment.

A process cartridge 200 illustrated in FIG. 2 is, for example, a cartridge obtained by using a housing 117 equipped with a guide rail 116 and an exposure opening 118 so as to integrate a photoreceptor 107 (one example of the image bearing member), and a charging roll 108 (one example of the charging unit), a developing device 111 (one example of the developing unit), and a photoreceptor cleaning device 113 (one example of the cleaning unit) provided around the photoreceptor 107.

In FIG. 2, 109 denotes an exposure device (one example of the electrostatic charge image forming unit), 112 denotes a transfer device (one example of the transfer unit), 115 denotes a fixing device (one example of the fixing unit), and 300 denotes a recording sheet (one example of the recording medium).

Next, a toner cartridge according to an exemplary embodiment is described.

The toner cartridge according to this exemplary embodiment stores the toner of the exemplary embodiment and is detachably attachable to an image forming apparatus. The toner cartridge stores replenishing toner to be supplied to a developing unit disposed inside the image forming apparatus.

Note that the image forming apparatus illustrated in FIG. 1 has detachably attachable toner cartridges 8Y, 8M, 8C, and 8K that are respectively connected to the developing devices 4Y, 4M, 4C, and 4K of the corresponding colors via toner supply tubes not illustrated in the drawing. In addition, when the toner level in the toner cartridge has run low, the cartridge is replaced.

### EXAMPLES

Examples, which do not limit the scope of the present disclosure, will now be described. In the description below, “parts” and “%” are all on a mass basis unless otherwise noted.

Preparation of amorphous resin particle dispersion (1)
terephthalic acid: 74.5 parts by mol
fumaric acid: 3.0 parts by mol
adipic acid: 3.8 parts by mol
bisphenol A ethylene oxide 2-mol adduct: 86.9 parts by mol
bisphenol A propylene oxide 2-mol adduct: 71.1 parts by mol

The aforementioned materials are placed in a reactor equipped with a stirrer, a nitrogen inlet tube, a temperature sensor, and a distillation column, the temperature is elevated to 200° ° C. over a period of 1 hour, and 1.1 parts of dibutyl tin oxide is added to 100 parts of the aforementioned materials. The temperature is elevated to 240° C. over a period of 5 hours while distilling away the generated water, the dehydration and condensation reaction is continued for 3 hours by maintaining 240° C., and then the reaction product is cooled.

The reaction product in a melted state is transferred to CAVITRON CD1010 (produced by EUROTEC LTD.) at a rate of 100 g per minute. Simultaneously, an ammonia water separately prepared having a concentration of 0.33 mass % is transferred to CAVITRON CD1010 at a rate of 0.1 L per minute while being heated to 150° C. with a heat exchanger. CAVITRON CD1010 is run under conditions of rotation rate of rotor: 60 Hz and pressure: 5 kg/cm² so as to obtain a resin particle dispersion in which resin particles having a volume-average particle diameter of 70 nm are dispersed. To this resin particle dispersion, ion exchange water is added to adjust the solid content to 30 mass %, and the resulting dispersion is used as an amorphous resin particle dispersion.

Preparation of amorphous resin particle dispersion (2)

An amorphous resin particle dispersion (2) is obtained as with the amorphous resin particle dispersion (1) except that the temperature after transfer to CAVITRON CD 1010 is changed to 135° C.

Preparation of amorphous resin particle dispersion (3)

An amorphous resin particle dispersion (3) is obtained as with the amorphous resin particle dispersion (1) except that the temperature after transfer to CAVITRON CD1010 is changed to 120° C. and the pressure is changed to 3 kg/cm².

Preparation of amorphous resin particle dispersion (4)

An amorphous resin particle dispersion (4) is obtained as with the amorphous resin particle dispersion (1) except that the temperature after transfer to CAVITRON CD1010 is changed to 120° ° C.and the pressure is changed to 2 kg/cm².

Preparation of amorphous resin particle dispersion (A1)

An amorphous resin particle dispersion (A1) is obtained as with the amorphous resin particle dispersion (1) except that the materials are changed as follows:
terephthalic acid: 82.3 parts by mol
fumaric acid: 0.2 parts by mol
adipic acid: 0.3 parts by mol
bisphenol A ethylene oxide 2-mol adduct: 80.6 parts by mol
bisphenol A propylene oxide 2-mol adduct: 77.4 parts by mol
   Preparation of amorphous resin particle dispersion (A2)

An amorphous resin particle dispersion (A2) is obtained as with the amorphous resin particle dispersion (1) except that the materials are changed as follows:
terephthalic acid: 81.3 parts by mol
fumaric acid: 0.6 parts by mol
adipic acid: 0.7 parts by mol
bisphenol A ethylene oxide 2-mol adduct: 80.6 parts by mol
bisphenol A propylene oxide 2-mol adduct: 77.4 parts by mol
   Preparation of amorphous resin particle dispersion (A3)

An amorphous resin particle dispersion (A3) is obtained as with the amorphous resin particle dispersion (1) except that the materials are changed as follows:
terephthalic acid: 58.1 parts by mol
fumaric acid: 8.7 parts by mol
adipic acid: 11.0 parts by mol
bisphenol A ethylene oxide 2-mol adduct: 99.5 parts by mol
bisphenol A propylene oxide 2-mol adduct: 58.5 parts by mol
   Preparation of amorphous resin particle dispersion S1
styrene: 72 parts
n-butyl acrylate: 27 parts
β-carboxyethyl acrylate: 1.3 parts
dodecanethiol: 2 parts

In a flask, a mixture prepared by mixing and dissolving the aforementioned materials is dispersed and emulsified with a surfactant solution prepared by dissolving 1.2 parts by mass of an anionic surfactant (TaycaPower produced by TAYCA Co., Ltd.) in 100 parts by mass of ion exchange water. Next, while the inside of the flask is stirred, an aqueous solution prepared by dissolving 6 parts by mass of aluminum persulfate in 50 parts by mass of ion exchange water is added over a period of 20 minutes. Next, after nitrogen purging, while the inside of the flask is stirred, the content thereof is heated until 75° C. over an oil bath, and the temperature of 75° C. is retained for 4 hours to continue emulsion polymerization. Thus, a resin particle dispersion in which resin particles of an amorphous styrene acryl resin having a volume-average particle diameter of 160 nm and a weight-average molecular weight of 56000 are dispersed is obtained. To this resin particle dispersion, ion exchange water is added to adjust the solid content to 31.4 mass % to prepare an amorphous resin particle dispersion S1.

sPreparation of crystalline resin particle dispersion (1)
dodecanedioic acid: 225 parts
1,6-hexanediol: 115 parts

The aforementioned materials are charged into a reactor equipped with a stirrer, a nitrogen inlet tube, a temperature sensor, and a distillation column, the temperature is elevated to 160° C. over a period of 1 hour, and 0.8 parts by mass of dibutyl tin oxide is added. The temperature is elevated to 180° C. over a period of 6 hours while distilling away the generated water, and the dehydration condensation reaction is continued for 5 hour by maintaining 180° C. Subsequently, the temperature is slowly decreased at a reduced pressure (3 kPa) until 230° C., and stirring is conducted while maintaining 230° C. for 2 hours. The reaction product is then cooled. After cooling, solid-liquid separation is performed and the solid is dried to obtain a crystalline polyester resin.

The crystalline polyester resin in a melted state is transferred to CAVITRON CD1010 (produced by EUROTEC LTD.) at a rate of 100 g per minute. Simultaneously, an ammonia water separately prepared having a concentration of 0.33 mass % is transferred to CAVITRON CD1010 at a rate of 0.1 L per minute while being heated to 90° C. with a heat exchanger. CAVITRON CD1010 is run under conditions of rotation rate of rotor: 60 Hz and pressure: 5 kg/cm² so as to obtain a resin particle dispersion in which crystalline resin particles are dispersed. To this resin particle dispersion, ion exchange water is added to adjust the solid content to 30 mass %, and the resulting dispersion is used as a crystalline resin particle dispersion (1).

Preparation of crystalline resin particle dispersion (2)

A crystalline resin particle dispersion (2) is obtained as with the crystalline resin particle dispersion (1) except that the temperature after transfer to CAVITRON CD1010 is changed to 105° C.

Preparation of crystalline resin particle dispersion (3)

A crystalline resin particle dispersion (3) is obtained as with the crystalline resin particle dispersion (1) except that the temperature after transfer to CAVITRON CD1010 is changed to 130° C.

Preparation of crystalline resin particle dispersion (4)

A crystalline resin particle dispersion (4) is obtained as with the crystalline resin particle dispersion (1) except that the temperature after transfer to CAVITRON CD1010 is changed to 80° C. and the pressure is changed to 3 kg/cm².

Preparation of crystalline resin particle dispersion (5)

A crystalline resin particle dispersion (5) is obtained as with the crystalline resin particle dispersion (1) except that the temperature after transfer to CAVITRON CD1010 is changed to 80° C. and the pressure is changed to 2 kg/cm².

Preparation of crystalline resin particle dispersion (B1)

A crystalline resin particle dispersion (B1) is obtained as with the crystalline resin particle dispersion (1) except that the materials are changed as follows:
dodecanedioic acid: 225 parts
ethylene glycol: 60 parts
   Preparation of crystalline resin particle dispersion (B2)

A crystalline resin particle dispersion (B2) is obtained as with the crystalline resin particle dispersion (1) except that the materials are changed as follows:
sebacic acid: 197 parts
1,6-hexanediol: 115 parts
   Preparation of crystalline resin particle dispersion (B3)

A crystalline resin particle dispersion (B3) is obtained as with the crystalline resin particle dispersion (1) except that the materials are changed as follows:
dodecanedioic acid: 137 parts
1,9-nonanediol: 156 parts
   Preparation of crystalline resin particle dispersion (B4)

A crystalline resin particle dispersion (B4) is obtained as with the crystalline resin particle dispersion (1) except that the materials are changed as follows:
tetradecanedioic acid: 253 parts
1,10-decanediol: 170 parts
   Preparation of crystalline resin particle dispersion (C1)

A crystalline resin particle dispersion (C1) is obtained as with the crystalline resin particle dispersion (1) except that the materials are changed as follows:
dodecanedioic acid: 180 parts
terephthalic acid: 45 parts
1,6-hexanediol: 124 parts
   Preparation of crystalline resin particle dispersion (C2)

A crystalline resin particle dispersion (C2) is obtained as with the crystalline resin particle dispersion (1) except that the materials are changed as follows:
dodecanedioic acid: 164 parts
terephthalic acid: 61 parts
1,6-hexanediol: 127 parts
   Preparation of crystalline resin particle dispersion (C3)

A crystalline resin particle dispersion (C3) is obtained as with the crystalline resin particle dispersion (1) except that the materials are changed as follows:
dodecanedioic acid: 137 parts
terephthalic acid: 88 parts
1,6-hexanediol: 133 parts
   Preparation of crystalline resin particle dispersion (C4)

A crystalline resin particle dispersion (C4) is obtained as with the crystalline resin particle dispersion (1) except that the materials are changed as follows:
dodecanedioic acid: 133 parts
terephthalic acid: 92 parts
1,6-hexanediol: 133 parts

The volume-average particle diameters of the amorphous resin particles and the crystalline resin particles in the amorphous resin particle dispersions and the crystalline resin particle dispersions prepared by the procedures described above are indicated in Tables 1-1 and 1-2.

Here, the volume-average particle diameters of the amorphous resin particles and the crystalline resin particles are measured by the same procedure as the aforementioned procedure for measuring the volume-average particle diameter of the toner particles.

TABLE 1-1
Amorphous resin particle dispersion

| Type | Volume-average particle diameter (nm) |
|---|---|
| 1 | 70 |
| A1 | 74 |
| A2 | 75 |
| A3 | 81 |
| 2 | 172 |
| 3 | 361 |
| 4 | 412 |
| S1 | 205 |

TABLE 1-2
Crystalline resin particle dispersion

| Type | Volume-average particle diameter (nm) |
|---|---|
| 1 | 170 |
| 2 | 67 |
| 3 | 54 |
| 4 | 389 |
| 5 | 406 |
| B1 | 165 |
| B2 | 163 |
| B3 | 170 |
| B4 | 169 |
| C1 | 161 |
| C2 | 164 |
| C3 | 171 |
| C4 | 165 |

Preparation of specified resin particle dispersion (1)
styrene: 48 parts
butyl acrylate: 52 parts
carboxyethyl acrylate: 0.3 parts
anionic surfactant (DOWFAX 2A1 produced by Dow Chemical Company): 0.8 parts
1,10-decanediol diacrylate: 1.8 parts

The aforementioned materials are mixed and dissolved, and combined with 60 parts of ion exchange water, and the resulting mixture is dispersed and emulsified in a flask to prepare an emulsion. Next, 1.3 parts of an anionic surfactant (DOWFAX 2A1 produced by Dow Chemical Company) is dissolved in 90 parts of ion exchange water, 1 part of the aforementioned emulsion is added thereto, and 10 parts of ion exchange water in which 5.4 parts of ammonium persulfate is dissolved is added to the resulting mixture. After the inside of the flask is nitrogen-purged, the solution in the flask is heated over an oil bath until 65° C. under stirring, the remaining emulsion is added thereto over a period of 3 hours, and the emulsion polymerization is continued in this state for 7 hours. The conversion rate of the monomers (in other words, styrene, butyl acrylate, carboxyethyl acrylate, and decanediol diacrylate) is confirmed to be 98.1%, 1.0 part of an anionic surfactant (DOWFAX 2A1 produced by Dow Chemical Company) is added at a liquid temperature of 65° C., the temperature is retained thereat for 1 hour, and the resulting mixture is rapidly cooled to 30° C. to obtain a specified resin particle dispersion (1).

Preparation of specified resin particle dispersion (2)

A specified resin particle dispersion (2) is obtained as with the specified resin particle dispersion (1) except that the amount of the raw material anionic surfactant (DOWFAX 2A1 produced by Dow Chemical Company) is changed to 1.8 parts and no anionic surfactant is added after confirming the conversion rate as 98.1%.

Preparation of specified resin particle dispersion (3)

A specified resin particle dispersion (3) is obtained as with the specified resin particle dispersion (1) except that the amount of the raw material styrene is changed to 42 parts and the amount of the raw material butyl acrylate is changed to 58 parts.

Preparation of specified resin particle dispersion (4)

A specified resin particle dispersion (4) is obtained as with the specified resin particle dispersion (1) except that the amount of the raw material styrene is changed to 38 parts and the amount of the raw material butyl acrylate is changed to 62 parts.

Preparation of specified resin particle dispersion (5)

A specified resin particle dispersion (5) is obtained as with the specified resin particle dispersion (1) except that the amount of the raw material styrene is changed to 51 parts and the amount of the raw material butyl acrylate is changed to 49 parts.

Preparation of specified resin particle dispersion (6)

A specified resin particle dispersion (6) is obtained as with the specified resin particle dispersion (1) except that the amount of the raw material styrene is changed to 55 parts and the amount of the raw material butyl acrylate is changed to 45 parts.

Preparation of specified resin particle dispersion (7)

A specified resin particle dispersion (7) is obtained as with the specified resin particle dispersion (1) except that the amount of the anionic surfactant in the mixture of the anionic surfactant (DOWFAX 2A1 produced by Dow Chemical Company) and 90 parts of ion exchange water to which 1 part of the emulsion is added is changed to 2.0 parts.

Preparation of specified resin particle dispersion (8)

A specified resin particle dispersion (8) is obtained as with the specified resin particle dispersion (1) except that the amount of the anionic surfactant in the mixture of the anionic surfactant (DOWFAX 2A1 produced by Dow Chemical Company) and 90 parts of ion exchange water to which 1 part of the emulsion is added is changed to 2.3 parts.

Preparation of specified resin particle dispersion (9)

A specified resin particle dispersion (9) is obtained as with the specified resin particle dispersion (1) except that the amount of the anionic surfactant in the mixture of the anionic surfactant (DOWFAX 2A1 produced by Dow Chemical Company) and 90 parts of ion exchange water to which 1 part of the emulsion is added is changed to 0.7 parts.

Preparation of specified resin particle dispersion (10)

A specified resin particle dispersion (10) is obtained as with the specified resin particle dispersion (1) except that the amount of the anionic surfactant in the mixture of the anionic surfactant (DOWFAX 2A1 produced by Dow Chemical Company) and 90 parts of ion exchange water to which 1 part of the emulsion is added is changed to 0.5 parts.

Preparation of specified resin particle dispersion (11)

A specified resin particle dispersion (11) is obtained as with the specified resin particle dispersion (1) except that the amount of the raw material 1,10-decanediol diacrylate is changed to 0 parts.

Preparation of specified resin particle dispersion (12)

A specified resin particle dispersion (12) is obtained as with the specified resin particle dispersion (1) except that the amount of the raw material 1,10-decanediol diacrylate is changed to 1.2 parts.

Preparation of specified resin particle dispersion (13)

A specified resin particle dispersion (13) is obtained as with the specified resin particle dispersion (1) except that the amount of the raw material 1,10-decanediol diacrylate is changed to 0.8 parts.

Preparation of specified resin particle dispersion (14)

A specified resin particle dispersion (14) is obtained as with the specified resin particle dispersion (1) except that the amount of the raw material 1,10-decanediol diacrylate is changed to 2.5 parts.

Preparation of specified resin particle dispersion (15)

A specified resin particle dispersion (15) is obtained as with the specified resin particle dispersion (1) except that the amount of the raw material 1,10-decanediol diacrylate is changed to 3.1 parts.

Preparation of specified resin particle dispersion (P1)
amorphous polyester resin particle dispersion 1: 160 parts
butyl acrylate: 102 parts
10% aqueous ammonia solution: 2.6 parts

The aforementioned components and 321 parts of ion exchange water are placed in a 2 L cylindrical stainless steel container, and dispersed and mixed with a homogenizer (ULTRA-TURRAX T50 produced by IKA Japan) at a rotation rate of 10000 rpm for 10 minutes. Subsequently, the raw material dispersion is transferred into a polymerization vessel equipped with a stirrer having two paddle stirring blades and a thermometer, heated with a mantle heater in a nitrogen atmosphere at a stirring rotation rate of 200 rpm, and retained at 65° C. for 30 minutes. Subsequently, a mixture of 1.8 parts of potassium persulfate and 120 parts of ion exchange water is added dropwise over a period of 120 minutes through a liquid feed pump, and then the temperature is retained at 75° C. for 210 minutes. After the liquid temperature is decreased to 50° C., 4.4 parts of an anionic surfactant (DOWFAX 2A1 produced by Dow Chemical Company) is added to obtain a specified resin particle dispersion P1 which is a particle dispersion of the specified resin dispersion resin P1.

The volume-average particle diameters of the specified resin particles in the specified resin particle dispersions prepared by the procedures described above are indicated in Table 1-3.

Here, the volume-average particle diameters of the specified resin particles are measured by the same procedure as the aforementioned procedure for measuring the volume-average particle diameter of the toner particles.

TABLE 1-3
Specified resin particle dispersion

| Type | Volume-average particle diameter (nm) |
|---|---|
| 1 | 174 |
| 2 | 174 |
| 3 | 174 |
| 4 | 174 |
| 5 | 174 |
| 6 | 174 |
| 7 | 64 |
| 8 | 55 |
| 9 | 291 |
| 10 | 311 |
| 11 | 174 |
| 12 | 174 |
| 13 | 174 |
| 14 | 174 |
| 15 | 174 |

Preparation of coloring agent particle dispersion
C. I. Pigment Blue 15:3 (Dainichiseika Color & Chemicals Mfg. Co.): 70 parts
anionic surfactant (NEOGEN RK produced by DKS Co. Ltd.): 5 parts
ion exchange water: 200 parts

The aforementioned materials are mixed and dispersed by using a homogenizer (ULTRA-TURRAX T50 produced by IKA Japan) for 10 minutes. Ion exchange water is added so that the solid content in the dispersion is 20 mass % to obtain a coloring agent dispersion in which coloring agent particles having a volume-average particle diameter of 170 nm are dispersed.

Preparation of releasing agent particle dispersion
synthetic wax (FNP92RF produced by Nippon Seiro Co., Ltd., melting temperature: 92° C.): 50 parts
anionic surfactant (TaycaPower produced by TAYCA Co. Ltd.): 1 part
ion exchange water: 150 parts

The aforementioned materials are mixed, heated to 95° C., and dispersed by using a homogenizer (ULTRA-TURRAX T50 produced by IKA Japan), and then the dispersed mixture is dispersed by using a Manton-Gaulin pressure homogenizer (produced by Gaulin Company) to obtain a releasing agent dispersion (solid content: 30 mass %) in which the releasing agent particles are dispersed. The volume-average particle diameter of the releasing agent particles is 250 nm.

### EXAMPLE 1

### Charging

amorphous resin particle dispersion (1): 165 parts
specified resin particle dispersion (1): 49 parts
crystalline resin particle dispersion (1): 70 parts
releasing agent dispersion: 25 parts
coloring agent dispersion: 33 parts
anionic surfactant (DOWFAX 2A1 produced by Dow Chemical Company): 4.8 parts

The aforementioned raw materials having a liquid temperature adjusted to 10° C. are placed in a 3 L cylindrical stainless steel container.

### Aggregated Particle Forming Step

The resulting mixture is dispersed and mixed by using a homogenizer (ULTRA-TURRAX T50 produced by IKA Japan) while applying shear force at 4000 rpm for 2 minutes. Next, 1.75 parts of a 10% aqueous aluminum sulfate solution serving as an aggregating agent is slowly added dropwise, and the resulting mixture is dispersed and mixed by using the homogenizer at a rotation rate of 10000 rpm for 10 minutes to prepare a raw material dispersion.

Subsequently, the raw material dispersion is transferred into a polymerization vessel equipped with a stirrer having two paddle stirring blades and a thermometer, heated with a mantle heater at a stirring rotation rate of 550 rpm, and retained at 40° C. to accelerate growth of the aggregated particles. During this process, the pH of the raw material dispersion is controlled to be in the range of 2.2 to 3.5 by using a 0.3 M nitric acid or a 1M aqueous sodium hydroxide solution. The pH is retained in the aforementioned range for about 2 hours to form aggregated particles.

### Step of Forming Core/Shell Structure Toner Particles

Next, 48 parts of the amorphous resin particle dispersion (1) is added, and the resulting mixture is retained for 30 minutes to attach the binder resin particles to the surfaces of the aggregated particles. The aggregated particles are prepared while checking the size and form of the particles with an optical microscope and MULTISIZER 3.

### Fusing and Coalescing Step

Next, the pH is adjusted to 7.8 by using a 5% aqueous sodium hydroxide solution, and retained thereat for 15 minutes. Then the pH is raised to 8.0 to fuse the aggregated particles and then the temperature is elevated to 85° C. Two hours after confirming the fusion of the aggregated particles with an optical microscope, the heating is stopped, and the temperature is decreased at a rate of 1.0° C./minute.

### Annealing Step

After the liquid temperature has reached 30° C., the temperature is increased at a heating rate of 1.0° C./minute to a first annealing temperature of 67° C.; after the temperature has reached 67° C., the temperature is decreased at a cooling rate of 5.0° C./minute to a second annealing temperature of 50° C.; after the temperature has reached 50° C., the temperature is elevated at a heating rate of 1.0° C./minute to a third annealing temperature of 61° C.; and the temperature is retained thereat for 3 hours as an annealing time, followed by discontinued heating and slow cooling to room temperature.

### Other Steps

Next, the obtained product is sifted through a 20 μm mesh screen, repeatedly washed with water, and dried by using a vacuum dryer at a drying temperature of 40° C. to obtain toner particles.

### Preparation of Toner and Developer

By using a Henschel mixer, 100 parts of the obtained toner particles and 0.7 parts of dimethylsilicone oil-treated silica particles (RY200 produced by Nippon Aerosil Co., Ltd.) are mixed to obtain a toner.

Then 8 parts of the obtained toner and 100 parts of a carrier produced by the following procedure are mixed to obtain a developer.

### Preparation of Carrier

ferrite particles (average particle diameter: 50 μm):100 parts
toluene: 14 parts
styrene-methyl methacrylate copolymer (copolymerization ratio of 15/85): 3 parts
carbon black: 0.2 parts

The aforementioned components other than the ferrite particles are dispersed using a sand mill to prepare a dispersion, and the dispersion and the ferrite particles are placed in a vacuum deaeration kneader and dried under stirring at a reduced pressure to obtain a carrier.

### Examples 2 to 42 and Comparative Examples 1 to 6

Toners and developers are prepared as in Example 1 except that “Type and amount of amorphous resin particle dispersion, crystalline resin particle dispersion, and specified resin particle dispersion”, “Presence or absence of annealing step”, “Annealing temperature in annealing step”, and “Toner drying temperature” are changed as indicated in Tables 2-1 and 2-2.

In Tables 2-1 and 2-2, three figures connected by arrows in the column of the annealing temperature respectively indicate, from left to right, the first annealing temperature, the second annealing temperature, and the third annealing temperature. When only one figure is indicated, annealing is performed at that temperature for the whole annealing time.

TABLE 2-1

| | | | Amount of | | | | | | | | |
|---|---|---|---|---|---|---|---|---|---|---|---|
| | | | amorphous | | | | | | | | |
| | | | resin | | Amount of | | Amount of | | | | |
| | | Type of | particle | Type of | crystalline | Type of | specified | | | | |
| | | amorphous | dispersion in | crystalline | resin | specified | resin | Presence/ | | | Toner |
| | | resin | raw material | resin | particle | resin | particle | absence of | Annealing | Annealing | drying |
| | | particle | charging | particle | dispersion | particle | dispersion | annealing | temperature | time | temperature |
| | | dispersion | (parts) | dispersion | (parts) | dispersion | (parts) | step | (° C.) | (hours) | (° C.) |
| Example | 1 | 1 | 165 | 1 | 70 | 1 | 49 | Present | 67→50→61 | 3 | 40 |
| Comparative | 1 | 1 | 165 | 1 | 90 | 11 | 49 | Absent | — | 0 | 40 |
| example | | | | | | | | | | | |
| Example | 2 | 1 | 165 | 1 | 70 | 1 | 49 | Present | 67→50→61 | 1 | 40 |
| Comparative | 2 | 1 | 165 | 1 | 70 | 1 | 49 | Present | 61 | 1 | 40 |
| example | | | | | | | | | | | |
| Example | 3 | 1 | 181 | 1 | 73 | 1 | 37 | Present | 67→50→61 | 3 | 40 |
| Comparative | 3 | 1 | 181 | 1 | 73 | 2 | 37 | Present | 67→50→61 | 3 | 40 |
| example | | | | | | | | | | | |
| Example | 4 | 1 | 165 | 1 | 52 | 1 | 49 | Present | 67→50→61 | 3 | 40 |
| Comparative | 4 | 1 | 165 | 1 | 51 | 1 | 49 | Present | 67→50→61 | 3 | 40 |
| example | | | | | | | | | | | |
| Example | 5 | 1 | 165 | 1 | 86 | 1 | 49 | Present | 67→50→61 | 3 | 40 |
| Comparative | 5 | 1 | 165 | 1 | 86 | 1 | 49 | Present | 67→50→61 | 3 | 40 |
| example | | | | | | | | | | | |
| Comparative | 6 | 1 | 165 | 1 | 70 | 11 | 49 | Present | 67→50→61 | 3 | 40 |
| example | | | | | | | | | | | |
| Example | 6 | 1 | 165 | 1 | 70 | 3 | 49 | Present | 67→50→61 | 3 | 40 |
| Example | 7 | 1 | 165 | 1 | 70 | 4 | 49 | Present | 67→50→61 | 3 | 40 |
| Example | 8 | 1 | 165 | 1 | 70 | 5 | 49 | Present | 67→50→61 | 3 | 40 |
| Example | 9 | 1 | 165 | 1 | 70 | 6 | 49 | Present | 67→50→61 | 3 | 40 |
| Example | 10 | 1 | 165 | 1 | 70 | 7 | 49 | Present | 67→50→61 | 3 | 40 |
| Example | 11 | 1 | 165 | 1 | 70 | 8 | 49 | Present | 67→50→61 | 3 | 40 |
| Example | 12 | 1 | 165 | 1 | 70 | 9 | 49 | Present | 67→50→61 | 3 | 40 |
| Example | 13 | 1 | 165 | 1 | 70 | 10 | 49 | Present | 67→50→61 | 3 | 40 |
| Example | 14 | 1 | 220 | 1 | 79 | 1 | 9 | Present | 67→50→61 | 3 | 40 |
| Example | 15 | 1 | 221 | 1 | 79 | 1 | 8 | Present | 67→50→61 | 3 | 40 |

TABLE 2-2

| | | | Amount of | | | | | | | | |
|---|---|---|---|---|---|---|---|---|---|---|---|
| | | | amorphous | | | | | | | | |
| | | | resin | | Amount of | | Amount of | | | | |
| | | Type of | particle | Type of | crystalline | Type of | specified | | | | |
| | | amorphous | dispersion in | crystalline | resin | specified | resin | Presence/ | | | Toner |
| | | resin | raw material | resin | particle | resin | particle | absence of | Annealing | Annealing | drying |
| | | particle | charging | particle | dispersion | particle | dispersion | annealing | temperature | time | temperature |
| | | dispersion | (parts) | dispersion | (parts) | dispersion | (parts) | step | (° C.) | (hours) | (° C.) |
| Example | 16 | 1 | 82 | 1 | 53 | 1 | 122 | Present | 67→50→61 | 3 | 40 |
| Example | 17 | 1 | 81 | 1 | 53 | 1 | 123 | Present | 67→50→61 | 3 | 40 |
| Example | 18 | 1 | 165 | 1 | 70 | P1 | 49 | Present | 67→50→61 | 3 | 40 |
| Example | 19 | 1 | 165 | B1 | 70 | 1 | 49 | Present | 67→50→61 | 3 | 40 |
| Example | 20 | 1 | 165 | B2 | 70 | 1 | 49 | Present | 67→50→61 | 3 | 40 |
| Example | 21 | 1 | 165 | B3 | 70 | 1 | 49 | Present | 67→50→61 | 3 | 40 |
| Example | 22 | 1 | 165 | B4 | 70 | 1 | 49 | Present | 67→50→61 | 3 | 40 |
| Example | 23 | 1 | 165 | 1 | 70 | 1 | 49 | Present | 67→50→61 | 3 | 45 |
| Example | 24 | 1 | 165 | 1 | 70 | 1 | 49 | Present | 67→50→61 | 3 | 35 |
| Example | 25 | 1 | 165 | 2 | 70 | 1 | 49 | Present | 67→50→61 | 3 | 40 |
| Example | 26 | 1 | 165 | 3 | 70 | 1 | 49 | Present | 67→50→61 | 3 | 40 |
| Example | 27 | 1 | 165 | 4 | 70 | 1 | 49 | Present | 67→50→61 | 3 | 40 |
| Example | 28 | 1 | 165 | 5 | 70 | 1 | 49 | Present | 67→50→61 | 3 | 40 |
| Example | 29 | S1 | 165 | 1 | 70 | 1 | 49 | Present | 67→50→61 | 3 | 40 |
| Example | 30 | A1 | 165 | 1 | 70 | 1 | 49 | Present | 67→50→61 | 3 | 40 |
| Example | 31 | A2 | 165 | 1 | 70 | 1 | 49 | Present | 67→50→61 | 3 | 40 |
| Example | 32 | A3 | 165 | C1 | 70 | 1 | 49 | Present | 67→50→61 | 3 | 40 |
| Example | 33 | A3 | 165 | C2 | 70 | 1 | 49 | Present | 67→50→61 | 3 | 40 |
| Example | 34 | 1 | 165 | C3 | 70 | 1 | 49 | Present | 67→50→61 | 3 | 40 |
| Example | 35 | 1 | 165 | C4 | 70 | 1 | 49 | Present | 67→50→61 | 3 | 40 |
| Example | 36 | 1 | 165 | 1 | 70 | 12 | 49 | Present | 67→50→61 | 3 | 40 |
| Example | 37 | 1 | 165 | 1 | 70 | 13 | 49 | Present | 67→50→61 | 3 | 40 |
| Example | 38 | 1 | 165 | 1 | 70 | 14 | 49 | Present | 67→50→61 | 3 | 40 |
| Example | 39 | 1 | 165 | 1 | 70 | 15 | 49 | Present | 67→50→61 | 3 | 40 |
| Example | 40 | 2 | 165 | 1 | 70 | 1 | 49 | Present | 67→50→61 | 3 | 40 |
| Example | 41 | 3 | 165 | 1 | 70 | 1 | 49 | Present | 67→50→61 | 3 | 40 |
| Example | 42 | 4 | 165 | 1 | 70 | 1 | 49 | Present | 67→50→61 | 3 | 40 |

### Evaluation

Evaluation of print blocking property

A developing device of a color copier, Versant 3100i Press (produced by FUJIFILM Business Innovation Corp.), without a fixing device is loaded with a developer, and fixed images are output on both surfaces by adjusting the toner coating amount to 0.100 mg/cm² and the image size to 100 mm×150 mm. A4-size OS coat paper W (basis weight: 157 g/m²), which is a printing paper produced by FUJIFILM Business Innovation Corp., is used as the recording medium.

In a 28° C., 95 RH% environment, 500 prints are made, stacked on top of each other in a discharge tray, and left standing overnight.

The stacked paper sheets are separated one by one, presence or absence of image omission is checked, and the print blocking property is evaluated on the basis of the number of sheets having image omissions. The evaluation standard is as follows.

Evaluation standard
G1: No image omission is found.
G2: The number of sheets with image omissions is 1 or more and less than 5.
G3: The number of sheets with image omissions is 5 or more and less than 10.
G4: The number of sheets with image omissions is 10 or more.
   Evaluation of fixability

A developing device of a color copier, ApeosPort IV C3370 (produced by FUJIFILM Business Innovation Corp.), without a fixing device is loaded with the obtained developer, and unfixed images are output by adjusting the toner coating amount to 0.45 mg/cm². A4 size P (thick) paper (basis weight: 78 gsm) produced by FUJIFILM Business Innovation Corp., is used as the recording medium. The output image has a 50 mm×50 mm image having an area coverage of 100%.

The unfixed image is fixed to a recording medium by using a fixing device, the fixed image is folded by using a weight, the folded portion is rubbed three times with a nonwoven cloth, BEMCOT M-3II (produced by Asahi Kasei Corporation) while a weight of 50 g is placed, and the image quality is evaluated on the basis of the area of the image omission in that portion. The device for evaluating the fixability is ApeosPort IV C3370 produced by FUJIFILM Business Innovation Corp., modified by removing the fixing device therefrom so that the fixing temperature can be altered. The fixing device temperature is 130° C., and the process speed is 225 mm/sec.

The evaluation standard is as follows.
G1: No image omission is found
G2: Slight image omission is found.
G3: Minor image omission is found but is within an acceptable range.
G4: Image omission is found.

TABLE 3-1

| | | Toner | | | | | | |
|---|---|---|---|---|---|---|---|---|
| | | Endothermic | | | | Maximum value | Amount of | Presence/absence |
| | | peak | Heat | Heat | | of loss | crystalline | of crosslinked |
| | | temperature | absorption | absorption | Ratio | coefficient tan δ | resin | structure in resin |
| | | Tc | Q1 | Q2 | (Q1/Q2) | (50° C. to 70° C.) | contained | particles |
| | | ° C. | J/g | J/g | — | — | mass % | — |
| Example | 1 | 69 | 8.1 | 14.3 | 0.566 | 1.09 | 20.3 | Present |
| Comparative | 1 | 70 | 2.5 | 18.2 | 0.139 | 1.25 | 26.1 | Absent |
| example | | | | | | | | |
| Example | 2 | 70 | 2.3 | 14.1 | 0.164 | 1.06 | 20.3 | Present |
| Comparative | 2 | 68 | 2.0 | 13.8 | 0.142 | 1.07 | 20.3 | Present |
| example | | | | | | | | |
| Example | 3 | 71 | 7.3 | 14.4 | 0.509 | 1.17 | 20.3 | Present |
| Comparative | 3 | 69 | 5.1 | 14 | 0.362 | 1.24 | 20.3 | Present |
| example | | | | | | | | |
| Example | 4 | 70 | 4.9 | 10.5 | 0.465 | 1.10 | 15.1 | Present |
| Comparative | 4 | 67 | 5.2 | 9.8 | 0.526 | 1.10 | 14.9 | Present |
| example | | | | | | | | |
| Example | 5 | 65 | 10.8 | 17.7 | 0.609 | 1.13 | 24.9 | Present |
| Comparative | 5 | 68 | 5.7 | 17.3 | 0.327 | 1.11 | 25.1 | Present |
| example | | | | | | | | |
| Comparative | 6 | 66 | 6.9 | 14.2 | 0.486 | 1.05 | 20.3 | Absent |
| example | | | | | | | | |
| Example | 6 | 70 | 6.7 | 13.9 | 0.484 | 1.11 | 20.3 | Present |
| Example | 7 | 68 | 6.2 | 14.1 | 0.438 | 1.12 | 20.3 | Present |
| Example | 8 | 69 | 7.5 | 14.3 | 0.525 | 1.10 | 20.3 | Present |
| Example | 9 | 67 | 8.4 | 13.8 | 0.61 | 1.14 | 20.3 | Present |
| Example | 10 | 67 | 7.2 | 13.5 | 0.535 | 1.14 | 20.3 | Present |
| Example | 11 | 69 | 5.3 | 14 | 0.376 | 1.06 | 20.3 | Present |
| Example | 12 | 69 | 6.4 | 13.9 | 0.457 | 1.08 | 20.3 | Present |
| Example | 13 | 68 | 5.7 | 13.3 | 0.427 | 1.14 | 20.3 | Present |
| Example | 14 | 72 | 8.1 | 13.7 | 0.591 | 1.16 | 20.3 | Present |
| Example | 15 | 73 | 7.4 | 13.6 | 0.543 | 1.18 | 20.3 | Present |
| Example | 16 | 65 | 7.1 | 14.7 | 0.483 | 1.01 | 20.3 | Present |
| Example | 17 | 67 | 6.1 | 13.2 | 0.46 | 0.91 | 20.3 | Present |

| | | Toner | Resin particles | | | |
|---|---|---|---|---|---|---|
| | | Storage | Storage | Number-average | Amount of | |
| | | modulus | modulus | particle | resin | Type of |
| | | G′ | G′(Rp) | diameter of | particles | resin |
| | | at 75° C. | at 50° C. | resin particles | contained | particles |
| | | Pa | Pa | nm | mass % | — |
| Example | 1 | 1.8E+05 | 5.1E+05 | 174 | 12 | St/Ac |
| Comparative | 1 | 5.90E+04 | 5.1E+05 | 174 | 12 | St/Ac |
| example | | | | | | |
| Example | 2 | 1.7E+05 | 5.1E+05 | 174 | 12 | St/Ac |
| Comparative | 2 | 1.8E+05 | 5.1E+05 | 174 | 12 | St/Ac |
| example | | | | | | |
| Example | 3 | 2.1E+05 | 5.1E+05 | 174 | 9 | St/Ac |
| Comparative | 3 | 2.2E+00 | 4.1E+05 | 174 | 9 | St/Ac |
| example | | | | | | |
| Example | 4 | 5.1E+05 | 5.1E+05 | 174 | 12 | St/Ac |
| Comparative | 4 | 6.4E+05 | 5.1E+05 | 174 | 12 | St/Ac |
| example | | | | | | |
| Example | 5 | 8.2E+04 | 5.1E+05 | 174 | 12 | St/Ac |
| Comparative | 5 | 7.4E+04 | 5.1E+05 | 174 | 12 | St/Ac |
| example | | | | | | |
| Comparative | 6 | 6.3E+05 | 4.3E+05 | 174 | 12 | St/Ac |
| example | | | | | | |
| Example | 6 | 2.6E+05 | 1.6E+05 | 174 | 12 | St/Ac |
| Example | 7 | 2.6E+05 | 8.9E+04 | 174 | 12 | St/Ac |
| Example | 8 | 9.0E+04 | 4.1E+07 | 174 | 12 | St/Ac |
| Example | 9 | 2.0E+04 | 6.3E+07 | 174 | 12 | St/Ac |
| Example | 10 | 1.1E+05 | 3.8E+05 | 64 | 12 | St/Ac |
| Example | 11 | 2.6E+05 | 4.7E+05 | 55 | 12 | St/Ac |
| Example | 12 | 3.2E+05 | 5.5E+05 | 291 | 12 | St/Ac |
| Example | 13 | 5.4E+05 | 4.7E+05 | 311 | 12 | St/Ac |
| Example | 14 | 2.1E+05 | 5.1E+05 | 174 | 2.1 | St/Ac |
| Example | 15 | 4.9E+05 | 5.1E+05 | 174 | 1.9 | St/Ac |
| Example | 16 | 1.1E+05 | 5.1E+05 | 174 | 29.8 | St/Ac |
| Example | 17 | 1.5E+05 | 5.1E+05 | 174 | 30.2 | St/Ac |

TABLE 3-2

| | | Toner | | | | | | |
|---|---|---|---|---|---|---|---|---|
| | | Endothermic | | | | Maximum value | Amount of | Presence/absence |
| | | peak | Heat | Heat | | of loss | crystalline | of crosslinked |
| | | temperature | absorption | absorption | Ratio | coefficient tan δ | resin | structure in resin |
| | | Tc | Q1 | Q2 | (Q1/Q2) | (50° C. to 70° C.) | contained | particles |
| | | ° C. | J/g | J/g | — | — | mass % | — |
| Example | 18 | 67 | 4.3 | 13.9 | 0.311 | 1.13 | 20.3 | Present |
| Example | 19 | 73 | 4.4 | 14.2 | 0.308 | 1.10 | 20.3 | Present |
| Example | 20 | 71 | 6.8 | 13.8 | 0.495 | 1.11 | 20.3 | Present |
| Example | 21 | 69 | 6.8 | 13.8 | 0.49 | 1.11 | 20.3 | Present |
| Example | 22 | 70 | 3.5 | 13.7 | 0.252 | 1.09 | 20.3 | Present |
| Example | 23 | 69 | 8.7 | 13.8 | 0.628 | 1.12 | 20.3 | Present |
| Example | 24 | 69 | 5.1 | 13.7 | 0.372 | 1.02 | 20.3 | Present |
| Example | 25 | 69 | 9.3 | 14.4 | 0.643 | 1.11 | 20.3 | Present |
| Example | 26 | 69 | 7.3 | 14.8 | 0.495 | 1.12 | 20.3 | Present |
| Example | 27 | 67 | 6.0 | 13.3 | 0.454 | 1.11 | 20.3 | Present |
| Example | 28 | 70 | 8.4 | 13.8 | 0.609 | 1.12 | 20.3 | Present |
| Example | 29 | 71 | 5.6 | 13.9 | 0.406 | 1.08 | 20.3 | Present |
| Example | 30 | 66 | 6.4 | 14 | 0.454 | 1.07 | 20.3 | Present |
| Example | 31 | 69 | 6.4 | 14.4 | 0.444 | 1.09 | 20.3 | Present |
| Example | 32 | 69 | 7.6 | 14.3 | 0.532 | 1.04 | 20.3 | Present |
| Example | 33 | 70 | 4.3 | 14.3 | 0.301 | 1.06 | 20.3 | Present |
| Example | 34 | 66 | 6.4 | 13.7 | 0.465 | 1.09 | 20.3 | Present |
| Example | 35 | 71 | 7.0 | 13.7 | 0.51 | 1.08 | 20.3 | Present |
| Example | 36 | 69 | 5.8 | 14.2 | 0.407 | 1.07 | 20.3 | Present |
| Example | 37 | 69 | 5.2 | 14 | 0.368 | 1.09 | 20.3 | Present |
| Example | 38 | 70 | 6.3 | 13.9 | 0.45 | 1.11 | 20.3 | Present |
| Example | 39 | 70 | 7.6 | 13.6 | 0.557 | 1.10 | 20.3 | Present |
| Example | 40 | 70 | 7.3 | 14.2 | 0.514 | 1.05 | 20.3 | Present |
| Example | 41 | 69 | 6.9 | 14.1 | 0.489 | 1.09 | 20.3 | Present |
| Example | 42 | 69 | 5.6 | 13.8 | 0.406 | 1.12 | 20.3 | Present |

| | | Toner | Resin particles | | | |
|---|---|---|---|---|---|---|
| | | Storage | Storage | Number-average | Amount of | |
| | | modulus | modulus | particle | resin | Type of |
| | | G′ | G′(Rp) | diameter of | particles | resin |
| | | at 75° C. | at 50° C. | resin particles | contained | particles |
| | | Pa | Pa | nm | mass % | — |
| Example | 18 | 1.2E+05 | 4.8E+05 | 174 | 12 | PES |
| Example | 19 | 1.8E+05 | 5.1E+05 | 174 | 12 | St/Ac |
| Example | 20 | 1.0E+05 | 5.1E+05 | 174 | 12 | St/Ac |
| Example | 21 | 2.3E+05 | 5.1E+05 | 174 | 12 | St/Ac |
| Example | 22 | 4.6E+05 | 5.1E+05 | 174 | 12 | St/Ac |
| Example | 23 | 3.3E+05 | 5.1E+05 | 174 | 12 | St/Ac |
| Example | 24 | 2.3E+05 | 5.1E+05 | 174 | 12 | St/Ac |
| Example | 25 | 3.8E+05 | 5.1E+05 | 174 | 12 | St/Ac |
| Example | 26 | 5.0E+04 | 5.1E+05 | 174 | 12 | St/Ac |
| Example | 27 | 7.0E+04 | 5.1E+05 | 174 | 12 | St/Ac |
| Example | 28 | 2.4E+05 | 5.1E+05 | 174 | 12 | St/Ac |
| Example | 29 | 1.3E+05 | 5.1E+05 | 174 | 12 | St/Ac |
| Example | 30 | 4.5E+05 | 5.1E+05 | 174 | 12 | St/Ac |
| Example | 31 | 1.4E+05 | 5.1E+05 | 174 | 12 | St/Ac |
| Example | 32 | 1.5E+05 | 5.1E+05 | 174 | 12 | St/Ac |
| Example | 33 | 4.4E+05 | 5.1E+05 | 174 | 12 | St/Ac |
| Example | 34 | 1.1E+05 | 5.1E+05 | 174 | 12 | St/Ac |
| Example | 35 | 7.2E+05 | 5.1E+05 | 174 | 12 | St/Ac |
| Example | 36 | 4.1E+04 | 5.9E+05 | 174 | 12 | St/Ac |
| Example | 37 | 1.5E+04 | 4.7E+05 | 174 | 12 | St/Ac |
| Example | 38 | 9.1E+05 | 6.7E+05 | 174 | 12 | St/Ac |
| Example | 39 | 1.8E+06 | 6.1E+05 | 174 | 12 | St/Ac |
| Example | 40 | 1.8E+05 | 5.1E+05 | 174 | 12 | St/Ac |
| Example | 41 | 2.1E+05 | 5.1E+05 | 174 | 12 | St/Ac |
| Example | 42 | 2.4E+05 | 5.1E+05 | 174 | 12 | St/Ac |

TABLE 4-1

| | | Binder resin | | | | | | | | |
|---|---|---|---|---|---|---|---|---|---|---|
| | | Sp value | Storage | Temperature | Type | Ratio of | Ratio of | | Evaluation | |
| | | (Amo) − | modulus | at which G′(t) | of | unit | unit | | Print | |
| | | Sp value | G′(t) at | reaches below | binder | represented | represented | | blocking | |
| | | (Cry) | 50° C. | 1 × 10⁵ Pa | resin | by formula (1) | by formula (2) | R1/R2 | property | Fixability |
| | | — | Pa | ° C. | — | mass % | mass % | — | — | — |
| Example | 1 | 0.58 | 2.8E+08 | 75 | PE | 10.3 | 100 | 0.10 | G1 | G1 |
| Comparative | 1 | 0.58 | 2.50E+08 | 71 | PE | 10.3 | 100 | 0.10 | G4 | G1 |
| example | | | | | | | | | | |
| Example | 2 | 0.58 | 2.8E+08 | 75 | PE | 10.3 | 100 | 0.10 | G3 | G2 |
| Comparative | 2 | 0.58 | 2.8E+08 | 75 | PE | 10.3 | 100 | 0.10 | G4 | G2 |
| example | | | | | | | | | | |
| Example | 3 | 0.58 | 2.8E+08 | 75 | PE | 10.3 | 100 | 0.10 | G3 | G2 |
| Comparative | 3 | 0.58 | 2.8E+08 | 75 | PE | 10.3 | 100 | 0.10 | G4 | G2 |
| example | | | | | | | | | | |
| Example | 4 | 0.58 | 4.1E+08 | 79 | PE | 10.3 | 100 | 0.10 | G2 | G3 |
| Comparative | 4 | 0.58 | 4.4E+08 | 81 | PE | 10.3 | 100 | 0.10 | G2 | G4 |
| example | | | | | | | | | | |
| Example | 5 | 0.58 | 2.2E+08 | 71 | PE | 10.3 | 100 | 0.10 | G3 | G1 |
| Comparative | 5 | 0.58 | 1.8E+08 | 69 | PE | 10.3 | 100 | 0.10 | G4 | G1 |
| example | | | | | | | | | | |
| Comparative | 6 | 0.58 | 2.8E+08 | 75 | PE | 10.3 | 100 | 0.10 | G4 | G2 |
| example | | | | | | | | | | |
| Example | 6 | 0.58 | 2.8E+08 | 75 | PE | 10.3 | 100 | 0.10 | G2 | G2 |
| Example | 7 | 0.58 | 2.8E+08 | 75 | PE | 10.3 | 100 | 0.10 | G3 | G1 |
| Example | 8 | 0.58 | 2.8E+08 | 75 | PE | 10.3 | 100 | 0.10 | G2 | G2 |
| Example | 9 | 0.58 | 2.8E+08 | 75 | PE | 10.3 | 100 | 0.10 | G2 | G3 |
| Example | 10 | 0.58 | 2.8E+08 | 75 | PE | 10.3 | 100 | 0.10 | G2 | G2 |
| Example | 11 | 0.58 | 2.8E+08 | 75 | PE | 10.3 | 100 | 0.10 | G3 | G2 |
| Example | 12 | 0.58 | 2.8E+08 | 75 | PE | 10.3 | 100 | 0.10 | G2 | G2 |
| Example | 13 | 0.58 | 2.8E+08 | 75 | PE | 10.3 | 100 | 0.10 | G3 | G2 |
| Example | 14 | 0.58 | 2.8E+08 | 75 | PE | 10.3 | 100 | 0.10 | G2 | G2 |
| Example | 15 | 0.58 | 2.8E+08 | 75 | PE | 10.3 | 100 | 0.10 | G3 | G2 |
| Example | 16 | 0.58 | 2.8E+08 | 75 | PE | 10.3 | 100 | 0.10 | G2 | G2 |
| Example | 17 | 0.58 | 2.8E+08 | 75 | PE | 10.3 | 100 | 0.10 | G1 | G3 |

TABLE 4-2

| | | Binder resin | | | | | | | | |
|---|---|---|---|---|---|---|---|---|---|---|
| | | Sp value | Storage | Temperature | Type | Ratio of | Ratio of | | Evaluation | |
| | | (Amo) − | modulus | at which G′(t) | of | unit | unit | | Print | |
| | | Sp value | G′(t) at | reaches below | binder | represented | represented | | blocking | |
| | | (Cry) | 50° C. | 1 × 10⁵ Pa | resin | by formula (1) | by formula (2) | R1/R2 | property | Fixability |
| | | — | Pa | ° C. | — | mass % | mass % | — | — | — |
| Example | 18 | 0.58 | 2.8E+08 | 75 | PE | 10.3 | 100 | 0.10 | G2 | G1 |
| Example | 19 | 0.07 | 3.1E+08 | 74 | PE | 10.3 | 100 | 0.10 | G2 | G1 |
| Example | 20 | −0.1 | 2.7E+08 | 75 | PE | 10.3 | 100 | 0.10 | G3 | G1 |
| Example | 21 | 0.85 | 2.9E+08 | 74 | PE | 10.3 | 100 | 0.10 | G1 | G2 |
| Example | 22 | 1.03 | 2.7E+08 | 74 | PE | 10.3 | 100 | 0.10 | G1 | G3 |
| Example | 23 | 0.58 | 1.4E+08 | 75 | PE | 10.3 | 100 | 0.10 | G2 | G2 |
| Example | 24 | 0.58 | 8.1E+07 | 75 | PE | 10.3 | 100 | 0.10 | G3 | G2 |
| Example | 25 | 0.58 | 2.8E+08 | 72 | PE | 10.3 | 100 | 0.10 | G2 | G1 |
| Example | 26 | 0.58 | 2.8E+08 | 68 | PE | 10.3 | 100 | 0.10 | G3 | G1 |
| Example | 27 | 0.58 | 2.8E+08 | 88 | PE | 10.3 | 100 | 0.10 | G2 | G2 |
| Example | 28 | 0.58 | 2.8E+08 | 93 | PE | 10.3 | 100 | 0.10 | G2 | G3 |
| Example | 29 | 0.58 | 2.8E+08 | 75 | St/Ac | — | — | — | G2 | G3 |
| Example | 30 | 0.58 | 2.8E+08 | 75 | PE | 0.8 | 100 | 0.01 | G2 | G2 |
| Example | 31 | 0.58 | 2.8E+08 | 75 | PE | 2 | 100 | 0.02 | G3 | G2 |
| Example | 32 | 0.58 | 2.8E+08 | 75 | PE | 30 | 80 | 0.38 | G2 | G3 |
| Example | 33 | 0.58 | 2.8E+08 | 75 | PE | 30 | 73 | 0.41 | G3 | G3 |
| Example | 34 | 0.58 | 2.8E+08 | 75 | PE | 10.3 | 61 | 0.17 | G2 | G2 |
| Example | 35 | 0.58 | 2.8E+08 | 75 | PE | 10.3 | 59 | 0.17 | G3 | G2 |
| Example | 36 | 0.58 | 2.8E+08 | 75 | PE | 10.3 | 100 | 0.10 | G2 | G1 |
| Example | 37 | 0.58 | 2.8E+08 | 75 | PE | 10.3 | 100 | 0.10 | G3 | G1 |
| Example | 38 | 0.58 | 2.8E+08 | 75 | PE | 10.3 | 100 | 0.10 | G1 | G2 |
| Example | 39 | 0.58 | 2.8E+08 | 75 | PE | 10.3 | 100 | 0.10 | G1 | G3 |
| Example | 40 | 0.58 | 2.8E+08 | 75 | PE | 10.3 | 100 | 0.10 | G2 | G1 |
| Example | 41 | 0.58 | 2.8E+08 | 75 | PE | 10.3 | 100 | 0.10 | G3 | G2 |
| Example | 42 | 0.58 | 2.8E+08 | 75 | PE | 10.3 | 100 | 0.10 | G3 | G3 |

The abbreviations used in Tables 3-1, 3-2, 4-1, and 4-2 are as follows.
“Type of resin particles”: St/Ac indicates styrene (meth)acryl copolymer resin particles. PES indicates polyester.
“Type of binder resin”: PE indicates polyester. St/Ac indicates styrene acryl resin
“Amount of crystalline resin contained” indicates the amount of the crystalline resin contained relative to the total amount of the amorphous resin and the crystalline resin.
The storage modulus G′ at 75° C., the storage modulus G′(Rp) at 50° C., and the storage modulus G′(t) at 50° C. are expressed exponentially.

The above-described results indicate that the toners of Examples reduce print blocking and exhibit excellent fixability.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1))) A toner for developing an electrostatic charge image, the toner comprising:
   toner particles containing:
      a binder resin containing an amorphous resin and a crystalline resin; and resin particles,
   wherein: in differential scanning calorimetry, an endothermic peak temperature Tc of the crystalline resin is 60° C. or higher and 75° C. or lower:
   a ratio (Q1/Q2) of a heat absorption Q1 of the crystalline resin calculated by performing differential scanning calorimetry on the toner that has been melted at 150° C., then cooled to a temperature 10° C. lower than the endothermic peak temperature Tc, and then retained thereat for 1 minute, to a heat absorption Q2 of the crystalline resin calculated by performing differential scanning calorimetry on the toner that has been melted at 150° C., then cooled to a temperature 10° C. lower than the endothermic peak temperature Tc, and then retained thereat for 30 minutes is 0.15 or more;
   a maximum value of a loss coefficient tan δ at 50° C. or higher and 70° C. or lower is less than 1.2;
   an amount of the crystalline resin contained relative to a total amount of the amorphous resin and the crystalline resin is 15 mass % or more and 25 mass % or less; and
   the resin particles are crosslinked resin particles.
(((2))) The toner for developing an electrostatic charge image described in (((1))), wherein the resin particles has a storage modulus G′(Rp) at 50° C. of 1×10⁵ Pa or more and 5×10⁷ Pa or less.
(((3))) The toner for developing an electrostatic charge image described in (((1))) or (((2))), wherein the resin particles have a number-average particle diameter of 60 nm or more and 300 nm or less.
(((4))) The toner for developing an electrostatic charge image described in any one of (((1))) to (((3))), wherein an amount of the resin particles contained relative to the entire toner particles is 2 mass % or more and 30 mass % or less.
(((5))) The toner for developing an electrostatic charge image described in any one of (((1))) to (((4))), wherein the crosslinked resin particles are styrene-(meth)acrylic copolymer resin particles.
(((6))) The toner for developing an electrostatic charge image described in any one of (((1))) to (((5))), wherein a difference (SP value (Amo)−SP value (Cry)) between a solubility parameter SP value (Amo) of the amorphous resin and a solubility parameter SP value (Cry) of the crystalline resin is 0 or more and 0.9 or less.
(((7))) The toner for developing an electrostatic charge image described in any one of (((1))) to (((6))), wherein, in measuring dynamic viscoelasticity of components in the toner particles other than the resin particles, a storage modulus G′(t) at 50° C. observed during heating at 2° C./minute is 1×10⁸ Pa or more, and a temperature at which the storage modulus G′(t) reaches below 1×10⁵ Pa is 70° C. or higher and 90° C. or lower.
(((8))) The toner for developing an electrostatic charge image described in any one of (((1))) to (((7))), wherein the binder resin is a polyester resin.
(((9))) The toner for developing an electrostatic charge image described in any one of (((1))) to (((8))), wherein:
   the amorphous resin contains an amorphous polyester resin that has an aliphatic dicarboxylic acid unit;
   the crystalline resin contains a crystalline polyester resin that has an aliphatic dicarboxylic acid unit;
   the amorphous polyester resin contains an amorphous polyester resin that has a unit represented by formula (1);
   the crystalline polyester resin contains a crystalline polyester resin that has a unit represented by formula (2);
   in the amorphous polyester resin that has the aliphatic dicarboxylic acid unit; the unit represented by formula (1) accounts for 1 mass % or more and 30 mass % or less of all dicarboxylic acid units; and in the crystalline polyester resin that has the aliphatic dicarboxylic acid unit; the unit represented by formula (2) accounts for 60 mass % or more and 100 mass % or less of all dicarboxylic acid units,

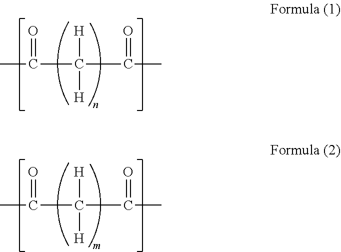

where, in formula (1), n represents an integer of 4 or more and 12 or less, and, in formula (2), m represents an integer of 4 or more and 12 or less.
(((10))) The toner for developing an electrostatic charge image described in (((9))), wherein a mass ratio R1 of the unit represented by formula (1) to all dicarboxylic acid units in the entire amorphous polyester resin and a mass ratio R2 of the unit represented by formula (2) to all dicarboxylic acid units in the entire crystalline polyester resin satisfy 0.01≤R1/R2≤0.40.
(((11))) The toner for developing an electrostatic charge image described in any one of (((1))) to (((10))), wherein a storage modulus G′ at 75° C. of the toner during heating is 2×10⁴ Pa or more and 1×10⁶ Pa or less.
(((12))) An electrostatic charge image developer comprising the toner for developing an electrostatic charge image described in any one of (((1))) to (((11))).
(((13))) A toner cartridge detachably attachable to an image forming apparatus, the toner cartridge comprising the toner for developing an electrostatic charge image described in any one of (((1))) to (((11))).
(((14))) A process cartridge detachably attachable to an image forming apparatus, the process cartridge comprising a developing unit that contains the electrostatic charge image developer described (((12))) and develops an electrostatic charge image on a surface of an image bearing member into a toner image by using the electrostatic charge image developer.
(((15))) An image forming apparatus comprising:
   an image bearing member;
a charging unit that charges a surface of the image bearing member;
   an electrostatic charge image forming unit that forms an electrostatic charge image on the charged surface of the image bearing member;
   a developing unit that contains the electrostatic charge image developer described in (((12))) and develops an electrostatic charge image on a surface of an image bearing member into a toner image by using the electrostatic charge image;
   a transfer unit that transfers the toner image on the surface of the image bearing member onto a surface of a recording medium; and
   a fixing unit that fixes the transferred toner image onto the surface of the recording medium.
(((16))) An image forming method comprising:
   charging a surface of an image bearing member;
   forming an electrostatic charge image on the charged surface of the image bearing member;
   developing the electrostatic charge image on the surface of the image bearing member into a toner image by using the electrostatic charge image developer described in (((12)));
   transferring the toner image on the surface of the image bearing member onto a surface of a recording medium; and
   fixing the transferred toner image onto the surface of the recording medium.

What is claimed is:

1. A toner for developing an electrostatic charge image, the toner comprising:
toner particles containing:
a binder resin containing an amorphous resin and a crystalline resin; and
resin particles,
wherein: in differential scanning calorimetry, an endothermic peak temperature Tc of the crystalline resin is 60° C. or higher and 75° C. or lower;
a ratio (Q1/Q2) of a heat absorption Q1 of the crystalline resin calculated by performing differential scanning calorimetry on the toner that has been melted at 150° C., then cooled to a temperature 10° C. lower than the endothermic peak temperature Tc, and then retained thereat for 1 minute, to a heat absorption Q2 of the crystalline resin calculated by performing differential scanning calorimetry on the toner that has been melted at 150° C., then cooled to a temperature 10° C. lower than the endothermic peak temperature Tc, and then retained thereat for 30 minutes is 0.15 or more;
a maximum value of a loss coefficient tan δ at 50° C. or higher and 70° C. or lower is less than 1.2;
an amount of the crystalline resin contained relative to a total amount of the amorphous resin and the crystalline resin is 15 mass % or more and 25 mass % or less; and
the resin particles are crosslinked resin particles.

2. The toner for developing an electrostatic charge image according to claim 1, wherein the resin particles has a storage modulus G′(Rp) at 50° C. of 1×10⁵ Pa or more and 5×10⁷ Pa or less.

3. The toner for developing an electrostatic charge image according to claim 1, wherein the resin particles have a number-average particle diameter of 60 nm or more and 300 nm or less.

4. The toner for developing an electrostatic charge image according to claim 1, wherein an amount of the resin particles contained relative to the entire toner particles is 2 mass % or more and 30 mass % or less.

5. The toner for developing an electrostatic charge image according to claim 1, wherein the crosslinked resin particles are styrene-(meth)acrylic copolymer resin particles.

6. The toner for developing an electrostatic charge image according to claim 1, wherein a difference (SP value (Amo)−SP value (Cry)) between a solubility parameter SP value (Amo) of the amorphous resin and a solubility parameter SP value (Cry) of the crystalline resin is 0 or more and 0.9 or less.

7. The toner for developing an electrostatic charge image according to claim 1, wherein, in measuring dynamic viscoelasticity of components in the toner particles other than the resin particles, a storage modulus G′(t) at 50° C. observed during heating at 2° C./minute is 1×10⁵ Pa or more, and a temperature at which the storage modulus G′(t) reaches below 1×10⁵ Pa is 70° C. or higher and 90° C. or lower.

8. The toner for developing an electrostatic charge image according to claim 1, wherein the binder resin is a polyester resin.

9. The toner for developing an electrostatic charge image according to claim 1, wherein:
the amorphous resin contains an amorphous polyester resin that has an aliphatic dicarboxylic acid unit;
the crystalline resin contains a crystalline polyester resin that has an aliphatic dicarboxylic acid unit;
the amorphous polyester resin contains an amorphous polyester resin that has a unit represented by formula (1);
the crystalline polyester resin contains a crystalline polyester resin that has a unit represented by formula (2);
in the amorphous polyester resin that has the aliphatic dicarboxylic acid unit, the unit represented by formula (1) accounts for 1 mass % or more and 30 mass % or less of all dicarboxylic acid units; and
in the crystalline polyester resin that has the aliphatic dicarboxylic acid unit, the unit represented by formula (2) accounts for 60 mass % or more and 100 mass % or less of all dicarboxylic acid units, 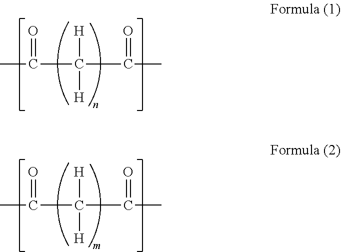
where, in formula (1), n represents an integer of 4 or more and 12 or less, and, in formula (2), m represents an integer of 4 or more and 12 or less.

10. The toner for developing an electrostatic charge image according to claim 9, wherein a mass ratio R1 of the unit represented by formula (1) to all dicarboxylic acid units in the entire amorphous polyester resin and a mass ratio R2 of the unit represented by formula (2) to all dicarboxylic acid units in the entire crystalline polyester resin satisfy 0.01≤R1/R2≤0.40.

11. The toner for developing an electrostatic charge image according to claim 1, wherein a storage modulus G′ at 75° C. of the toner during heating is 2×10⁴ Pa or more and 1×10⁶ Pa or less.

12. An electrostatic charge image developer comprising the toner for developing an electrostatic charge image according to claim 1.

13. An electrostatic charge image developer comprising the toner for developing an electrostatic charge image according to claim 2.

14. An electrostatic charge image developer comprising the toner for developing an electrostatic charge image according to claim 3.

15. An electrostatic charge image developer comprising the toner for developing an electrostatic charge image according to claim 4.

16. An electrostatic charge image developer comprising the toner for developing an electrostatic charge image according to claim 5.

17. A toner cartridge detachably attachable to an image forming apparatus, the toner cartridge comprising the toner for developing an electrostatic charge image according to claim 1.

18. A process cartridge detachably attachable to an image forming apparatus, the process cartridge comprising a developing unit that contains the electrostatic charge image developer according to claim 12 and develops an electrostatic charge image on a surface of an image bearing member into a toner image by using the electrostatic charge image developer.

19. An image forming apparatus comprising:
an image bearing member;
a charging unit that charges a surface of the image bearing member;
an electrostatic charge image forming unit that forms an electrostatic charge image on the charged surface of the image bearing member;
a developing unit that contains the electrostatic charge image developer according to claim 12 and develops an electrostatic charge image on a surface of an image bearing member into a toner image by using the electrostatic charge image;
a transfer unit that transfers the toner image on the surface of the image bearing member onto a surface of a recording medium; and
a fixing unit that fixes the transferred toner image onto the surface of the recording medium.

20. An image forming method comprising:
charging a surface of an image bearing member;
forming an electrostatic charge image on the charged surface of the image bearing member;
developing the electrostatic charge image on the surface of the image bearing member into a toner image by using the electrostatic charge image developer according to claim 12;
transferring the toner image on the surface of the image bearing member onto a surface of a recording medium; and
fixing the transferred toner image onto the surface of the recording medium.
